(19) United States
(12) Patent Application Publication
(10) Pub. No.: US 2026/0299358 A1
(43) Pub. Date: Oct. 1, 2026

(54) LIQUID CRYSTAL DISPLAY DEVICE AND ELECTRONIC APPARATUS

(71) Applicant: SONY SEMICONDUCTOR SOLUTIONS CORPORATION, KANAGAWA (JP)

(72) Inventor: SEIICHIRO JINTA, KANAGAWA (JP)

(21) Appl. No.: 19/479,519

(22) PCT Filed: Apr. 10, 2024
(86) PCT No.: PCT/JP2024/014508

§ 371 Date: Oct. 28, 2025

(30) Foreign Application Priority Data
May 17, 2023 (JP) 2023-081906

(51) Int. Cl. G02F 1/1343; G02F 1/1337; G02F 1/1339; G03B 21/00

(52) U.S. Cl. CPC G02F 1/134336; G02F 1/133707; G02F 1/1339; G03B 21/006

(57) ABSTRACT

To provide a liquid crystal display device capable of suppressing deterioration of display characteristics. A liquid crystal display device according to the present disclosure includes a first electrode provided in an effective pixel region in which pixels are arranged in a two-dimensional array, a second electrode opposed to the first electrode in a first direction, a liquid crystal provided between the first electrode and the second electrode, a first protective film and a second protective film opposed to each other in the first direction with the liquid crystal sandwiched between the first protective film and the second protective film in the effective pixel region, a first alignment film covered with the first protective film in the effective pixel region, a second alignment film covered with the second protective film in the effective pixel region, and a third electrode opposed to the second electrode in the first direction in a non-effective region located outside the effective pixel region. At least one of the first alignment film and the second alignment film is exposed in the non-effective region and is in contact with the liquid crystal.

### TECHNICAL FIELD

The present disclosure relates to a liquid crystal display device and an electronic apparatus.

### BACKGROUND ART

As image display devices, for example, liquid crystal display devices having high transmittance for which a liquid crystal panel is employed are known. In such a liquid crystal display device, it is necessary to apply relatively high voltages to pixels when an image is displayed.

For this reason, ionic impurities in the liquid crystal panel are diffused or aggregated in a pixel region by driving the liquid crystal display device, thereby causing deterioration of display characteristics of the liquid crystal panel.

### CITATION LIST

### Patent Document

Patent Document 1: Japanese Patent Application Laid-Open No. 2020-42293

Patent Document 2: Japanese Patent Application Laid-Open No. 2020-16681

### SUMMARY OF THE INVENTION

### Problems to be Solved by the Invention

Therefore, the present disclosure provides a liquid crystal display device and an electronic apparatus capable of suppressing deterioration of display characteristics.

### Solutions to Problems

A liquid crystal display device according to an aspect of the present disclosure includes a first electrode provided in an effective pixel region in which pixels are arranged in a two-dimensional array, a second electrode opposed to the first electrode in a first direction, a liquid crystal provided between the first electrode and the second electrode, a first protective film and a second protective film opposed to each other in the first direction with the liquid crystal sandwiched between the first protective film and the second protective film in the effective pixel region, a first alignment film covered with the first protective film in the effective pixel region, a second alignment film covered with the second protective film in the effective pixel region, and a third electrode opposed to the second electrode in the first direction in a non-effective region located outside the effective pixel region. At least one of the first alignment film and the second alignment film is exposed in the non-effective region and is in contact with the liquid crystal.

The first alignment film and the second alignment film provided in the non-effective region may be separated from the first alignment film and the second alignment film provided in the effective pixel region.

The second electrode provided in the non-effective region may be separated from the second electrode provided in the effective pixel region.

The liquid crystal display device may further include a sealant in contact with the first alignment film and the second alignment film outside the effective pixel region, in which the first alignment film and the second alignment film provided in the non-effective region may be separated from the first alignment film and the second alignment film in contact with the sealant.

The liquid crystal display device may further include a plug that closes an injection port of the liquid crystal, in which the first alignment film and the second alignment film may each have a protrusion protruding toward the plug at a portion facing the plug.

The first alignment film and the second alignment film may surround the effective pixel region with multiple layers.

The liquid crystal display device may perform refresh driving of applying different voltages to a plurality of the first electrodes adjacent to each other.

At a time of the refresh driving, the second electrode and the third electrode disposed on a sealant side in the non-effective region may have a same potential.

At a time of the refresh driving, a moving image pattern in which gradation of voltages applied to the plurality of first electrodes is scrolled may be displayed in the effective pixel region.

The refresh driving may be performed alternately with normal display based on a video signal.

The refresh driving may be performed every other image display unit.

The refresh driving may be performed in two image display units.

The gradation of the voltages may be set within a range of 2 V to 3 V.

A first moving image pattern and a second moving image pattern may be alternately displayed at the time of the refresh driving, and
a range of the gradation of the voltages in the second moving image pattern may be narrower than a range of the gradation of the voltages in the first moving image pattern.

The liquid crystal display device may further include a signal processing circuit that extracts, at a time of the refresh driving, an adjacent pixel region in which pixels having a same grayscale value and adjacent to each other are arranged in the effective pixel region and that sets a voltage difference between the first electrode and the second electrode to be different between the adjacent pixels in the adjacent pixel region.

The pixels may each include a first pixel portion arranged in a light transmission region in the effective pixel region and a second pixel portion arranged in a non-light transmission region in the effective pixel region,
the first pixel portion may include a first pixel transistor, and the second pixel portion may include a second pixel transistor, and
the second pixel transistor may be connected to a gate line and a signal line different from a gate line and a signal line of the first pixel transistor.

The pixels may each include a first pixel portion arranged in a light transmission region in the effective pixel region and a second pixel portion arranged in a non-light transmission region in the effective pixel region,
the first pixel portion may include a first pixel transistor, and the second pixel portion may include a second pixel transistor, and
the second pixel transistor may be connected to a gate line different from a gate line of the first pixel transistor and a same signal line as a signal line of the first pixel transistor.

The pixels may each include a first pixel portion arranged in a light transmission region in the effective pixel region and a second pixel portion arranged in a non-light transmission region in the effective pixel region,
the first pixel portion may include a pixel transistor, and the second pixel portion may include a resistance element, and
the resistance element may be connected to two voltage pass lines having different potentials.

A series connection of a plurality of the resistance elements may be divided by the voltage pass lines in such a way as to generate a lateral electric field having two types of voltage changes in the effective pixel region.

An electronic apparatus according to one aspect of the present disclosure includes a liquid crystal display device. The liquid crystal display device includes
a first electrode provided in an effective pixel region in which pixels are arranged in a two-dimensional array;
a second electrode opposed to the first electrode in a first direction;
a liquid crystal provided between the first electrode and the second electrode;
a first protective film and a second protective film opposed to each other in the first direction with the liquid crystal sandwiched between the first protective film and the second protective film in the effective pixel region;
a first alignment film covered with the first protective film in the effective pixel region;
a second alignment film covered with the second protective film in the effective pixel region; and
a third electrode opposed to the second electrode in the first direction in a non-effective region located outside the effective pixel region. At least one of the first alignment film and the second alignment film is exposed in the non-effective region and is in contact with the liquid crystal.

### BRIEF DESCRIPTION OF DRAWINGS

FIG. 1 is a schematic diagram illustrating a schematic configuration of a liquid crystal display device according to a first embodiment.

FIG. 2 is an exploded perspective view illustrating a structure example of a liquid crystal panel.

FIG. 3 is an exploded perspective view illustrating a modification of the liquid crystal panel.

FIG. 4 is a perspective view illustrating structure of a main part of a TFT substrate.

FIG. 5 is a schematic diagram illustrating configuration of a pixel.

FIG. 6 is an equivalent circuit diagram of the pixel.

FIG. 7 is a diagram illustrating an example of DC driving of a liquid crystal.

FIG. 8 is a diagram illustrating an example of AC driving of the liquid crystal.

FIG. 9 is a diagram illustrating an example of a circuit layout of the TFT substrate.

FIG. 10 is a diagram for explaining an image sticking phenomenon of the liquid crystal.

FIG. 11 is a diagram for explaining a cause of occurrence of a line image sticking phenomenon.

FIG. 12 is a diagram for explaining a cause of occurrence of an area image sticking phenomenon.

FIG. 13 is a cross-sectional perspective view for explaining a source of impurity ions.

FIG. 14 is a plan view for explaining a liquid crystal injection method.

FIG. 15 is a plan view for explaining a liquid crystal dropping method.

FIG. 16A is a plan view illustrating a schematic structure of a liquid crystal panel according to a comparative example.

FIG. 16B is a cross-sectional view taken along section line A0-A0 illustrated in FIG. 16A.

FIG. 17A is a plan view illustrating a schematic structure of a liquid crystal panel according to a first embodiment.

FIG. 17B is a cross-sectional view taken along section line A1-A1 illustrated in FIG. 17A.

FIG. 18A is a plan view illustrating a schematic structure of a liquid crystal panel according to a second embodiment.

FIG. 18B is a cross-sectional view taken along section line A2-A2 illustrated in FIG. 18A.

FIG. 19A is a plan view illustrating a schematic structure of a liquid crystal panel according to a third embodiment.

FIG. 19B is a cross-sectional view taken along section line A3-A3 illustrated in FIG. 19A.

FIG. 20A is a plan view illustrating a schematic structure of a liquid crystal panel according to a fourth embodiment.

FIG. 20B is a cross-sectional view taken along section line A4-A4 illustrated in FIG. 20A.

FIG. 21A is a plan view illustrating a schematic structure of a liquid crystal panel according to a fifth embodiment.

FIG. 21B is a cross-sectional view taken along section line A5-A5 illustrated in FIG. 21A.

FIG. 22A is a plan view illustrating a schematic structure of a liquid crystal panel according to a sixth embodiment.

FIG. 22B is a cross-sectional view taken along section line A6-A6 illustrated in FIG. 22A.

FIG. 23 is a waveform diagram of a pixel signal Vpix.

FIG. 24A is a cross-sectional view illustrating a state inside the liquid crystal at a time when white raster display with positive application is performed in a liquid crystal panel according to a seventh embodiment.

FIG. 24B is a cross-sectional view illustrating a state inside the liquid crystal at a time when white raster display with negative application is performed in the liquid crystal panel according to the seventh embodiment.

FIG. 25A is a cross-sectional view illustrating a state inside the liquid crystal at a time when ramp display with positive application is performed in the liquid crystal panel according to the seventh embodiment.

FIG. 25B is a cross-sectional view illustrating a state inside the liquid crystal 440 at a time when ramp display with negative application is performed in the liquid crystal panel according to the seventh embodiment.

FIG. 26 is a diagram illustrating an example of VT characteristics of the liquid crystal.

FIG. 27A is a plan view illustrating a basic pattern of a still image displayed by refresh driving for moving impurity ions.

FIG. 27B is a plan view illustrating a left-right division pattern of a still image displayed by the refresh driving for moving impurity ions.

FIG. 27C is a plan view illustrating a top-bottom division pattern of a still image displayed by the refresh driving for moving impurity ions.

FIG. 27D is a plan view illustrating a radial pattern of a still image displayed by the refresh driving for moving impurity ions.

FIG. 28A is a plan view illustrating a basic pattern of a moving image displayed by the refresh driving for moving impurity ions.

FIG. 28B is a plan view illustrating a left-right division pattern of a moving image displayed by the refresh driving for moving impurity ions.

FIG. 28C is a plan view illustrating a top-bottom division pattern of a moving image displayed by the refresh driving for moving impurity ions.

FIG. 28D is a plan view illustrating a radial pattern of a moving image displayed by the refresh driving for moving impurity ions.

FIG. 29A is a diagram illustrating an example of image display timings of the liquid crystal panel according to the seventh embodiment.

FIG. 29B is a diagram illustrating a first modification of the image display timings of the liquid crystal panel according to the seventh embodiment.

FIG. 29C is a diagram illustrating a second modification of the image display timings of the liquid crystal panel according to the seventh embodiment.

FIG. 30A is a plan view illustrating a pattern example of a moving image according to an eighth embodiment.

FIG. 30B is a plan view illustrating a pattern example of a moving image according to a modification of the eighth embodiment.

FIG. 31A is a diagram illustrating a display pattern that cannot be employed in a ninth embodiment.

FIG. 31B is a diagram illustrating another display pattern that cannot be employed in the ninth embodiment.

FIG. 32A is a diagram illustrating an example of a display pattern employed in the ninth embodiment.

FIG. 32B is a diagram illustrating another example of the display pattern employed in the ninth embodiment.

FIG. 32C is a moving image generated by alternately displaying a moving image illustrated in FIG. 32A and a moving image illustrated in FIG. 32B.

FIG. 33A is a diagram illustrating an example of an input image input to a liquid crystal panel according to a tenth embodiment.

FIG. 33B is a diagram illustrating adjacent pixel regions extracted from the image illustrated in FIG. 33A.

FIG. 33C is a diagram illustrating an example of an output image displayed on the liquid crystal panel according to the tenth embodiment.

FIG. 34A is a cross-sectional view illustrating a voltage application state of an adjacent pixel region at a time when an input image of positive application is displayed.

FIG. 34B is a cross-sectional view illustrating a voltage application state of the adjacent pixel region at a time when an input image of negative application is displayed.

FIG. 35A is a cross-sectional view illustrating a voltage application state of an adjacent pixel region at a time when an output image of positive application is displayed.

FIG. 35B is a cross-sectional view illustrating a voltage application state of the adjacent pixel region at a time when an output image of negative application is displayed.

FIG. 36A is an equivalent circuit diagram of pixels according to an eleventh embodiment.

FIG. 36B is a layout diagram of an effective pixel region including the pixels illustrated in FIG. 36A.

FIG. 36C is a diagram illustrating drive configuration of the pixels arranged in the effective pixel region illustrated in FIG. 36B.

FIG. 37A is an equivalent circuit diagram of pixels according to a twelfth embodiment.

FIG. 37B is a layout diagram of an effective pixel region including the pixels illustrated in FIG. 37A.

FIG. 37C is a diagram illustrating drive configuration of the pixels arranged in the effective pixel region illustrated in FIG. 37B.

FIG. 38 is a diagram illustrating drive configuration of a pixel according to a first modification of the twelfth embodiment.

FIG. 39 is a diagram illustrating drive configuration of a pixel according to a second modification of the twelfth embodiment.

FIG. 40 is an equivalent circuit diagram of pixels according to a thirteenth embodiment.

FIG. 41 is a diagram illustrating an example of a lateral electric field generated in the effective pixel region in a case where resistance division is not performed.

FIG. 42 is a diagram illustrating an example of a lateral electric field generated in the effective pixel region in a case where the resistance division is performed.

FIG. 43 is a diagram illustrating a modification of a lateral electric field generated in the effective pixel region in a case where the resistance division is performed.

FIG. 44 is a layout diagram of an effective pixel region including the pixels according to the thirteenth embodiment.

FIG. 45 is a layout diagram of an effective pixel region according to a first modification of the thirteenth embodiment.

FIG. 46 is a layout diagram of an effective pixel region according to a second modification of the thirteenth embodiment.

FIG. 47 is a layout diagram of an effective pixel region according to a third modification of the thirteenth embodiment.

FIG. 48 is a layout diagram of an effective pixel region according to a fourth modification of the thirteenth embodiment.

FIG. 49 is a view illustrating an example of external appearance of a head mounted display.

FIG. 50 is a view illustrating an example of external appearance of another head mounted display.

FIG. 51A is a front view of a digital still camera.

FIG. 51B is a rear view of the digital still camera.

FIG. 52 is a view illustrating an example of external appearance of a television apparatus.

FIG. 53 is a view illustrating an example of external appearance of a smartphone.

FIG. 54A is a view illustrating an example of an inside of a vehicle as viewed from a rear portion of a vehicle.

FIG. 54B is a view illustrating an example of the inside of the vehicle as viewed from a left rear portion of the vehicle.

FIG. 55 is a diagram illustrating an optical configuration example of a liquid crystal projector.

### MODE FOR CARRYING OUT THE INVENTION

Some embodiments of a liquid crystal display device and an electronic apparatus according to the present disclosure will be described hereinafter with reference to the drawings. Main components of the liquid crystal display device and the electronic apparatus will be mainly described hereinafter. The liquid crystal display device and the electronic apparatus according to each embodiment, however, can include components and functions that are not illustrated or described. The following description is not intended to exclude components and functions that are not illustrated or described.

### First Embodiment

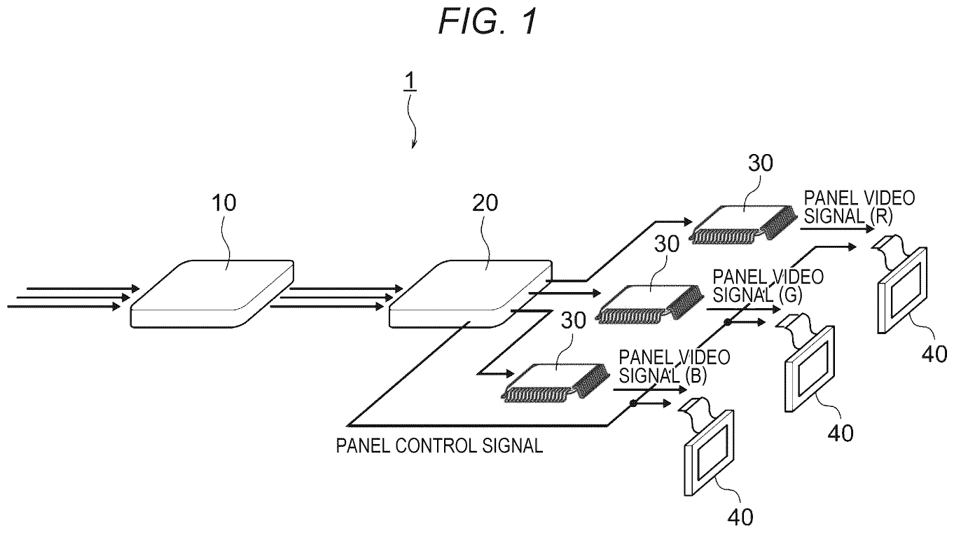

FIG. 1 is a schematic diagram illustrating a schematic configuration of a liquid crystal display device according to a first embodiment. A liquid crystal display device 1 according to the present embodiment is, for example, an active matrix liquid crystal display device. In the active matrix liquid crystal display device, a voltage based on a video signal is applied to and held in each pixel by turning on and off a pixel transistor provided for the pixel.

As illustrated in FIG. 1, the liquid crystal display device 1 according to the present embodiment includes a scaling IC 10, a signal processing circuit 20, digital analog converters (DACs) 30, and liquid crystal panels 40. Although three DACs 30 and three liquid crystal panels 40 are provided in the liquid crystal display device 1, it is sufficient that at least one DAC 30 and at least one liquid crystal panel 40 are provided.

Three video signals respectively corresponding to red, green, and blue are input to the scaling IC 10. The scaling IC 10 performs processing of converting these video signals into video signals corresponding to the number of pixels of the liquid crystal panels 40. The converted video signals are, for example, 10 bit digital signals.

The signal processing circuit 20 performs digital signal processing necessary for driving the liquid crystal panels 40. For example, the signal processing circuit 20 executes, as the digital signal processing, processing of creating panel video signals by performing gamma conversion processing, color unevenness correction processing, and the like on the video signals input from the scaling IC 10, processing of creating panel control signals for controlling the liquid crystal panels 40, and the like.

Each DAC 30 converts the digital panel video signal input from the signal processing circuit 20 into an analog panel video signal. The analog panel video signals are input, as red, green, and blue video signals, to the liquid crystal panels 40 corresponding to these colors. In addition, each liquid crystal panel 40 is driven on the basis of the panel control signal.

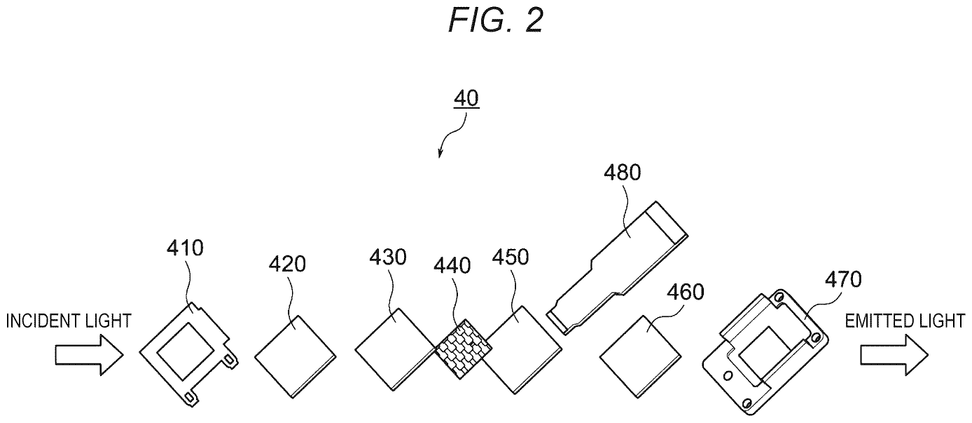

FIG. 2 is an exploded perspective view illustrating a structure example of the liquid crystal panel 40. The liquid crystal panel 40 illustrated in FIG. 2 has a high temperature poly-silicon (HTPS) structure. In the liquid crystal panel 40, a parting plate 410, a first dustproof glass 420, a counter substrate 430, a liquid crystal 440, a thin film transistor (TFT) substrate 450, a second dustproof glass 460, and an outer frame 470 are arranged in this order. In addition, a flexible cable 480 is connected to the TFT substrate 450.

In the liquid crystal panel 40, light enters the parting plate 410. This light is generated by, for example, a backlight (not illustrated), polarized by a polarizing plate (not illustrated), and incident on the parting plate 410. Thereafter, the incident light sequentially passes through the first dustproof glass 420, the counter substrate 430, the liquid crystal 440, the TFT substrate 450, and the second dustproof glass 460, and is emitted from the outer frame 470. At this time, transmittance of the liquid crystal 440 changes according to the panel video signal and the panel control signal input to the TFT substrate 450 through the flexible cable 480. As a result, the emitted light shows an image based on the panel video signal. Note that the structure of the liquid crystal panel is not limited to the HTPS structure.

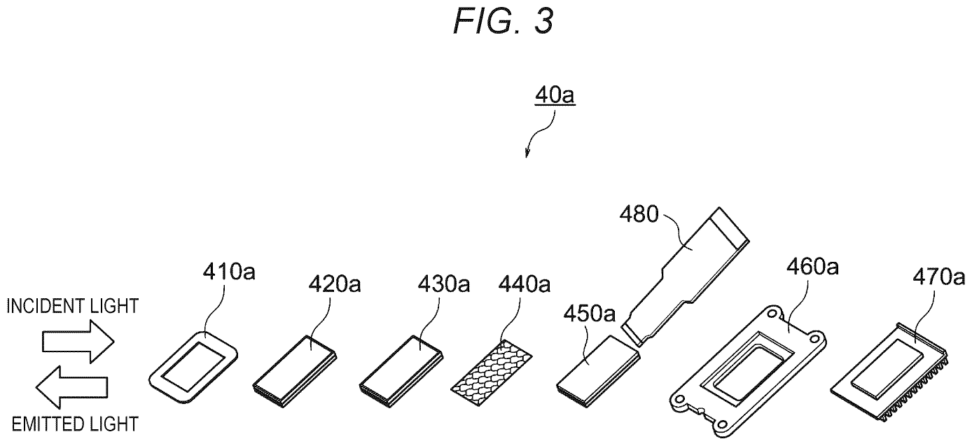

FIG. 3 is an exploded perspective view illustrating a modification of the liquid crystal panel. A liquid crystal panel 40a illustrated in FIG. 3 has a liquid crystal on silicon (LCOS) structure. In the liquid crystal panel 40a, a black mask 410a, a first dustproof glass 420a, a counter substrate 430a, a liquid crystal 440a, a silicon substrate 450a, a panel holder 460a, and a heat sink 470a are arranged in this order. In addition, the flexible cable 480 is connected to the silicon substrate 450a.

In the liquid crystal panel 40a, light enters the black mask 410a. The incident light sequentially passes through the first dustproof glass 420a, the counter substrate 430a, and the liquid crystal 440a, and is reflected by the silicon substrate 450a. The reflected light travels in a direction opposite to the incident light and is emitted from the black mask 410a. At this time, transmittance of the liquid crystal 440a changes according to the panel video signal and the panel control signal input to the silicon substrate 450a through the flexible cable 480. As a result, the emitted light shows an image based on the panel video signal.

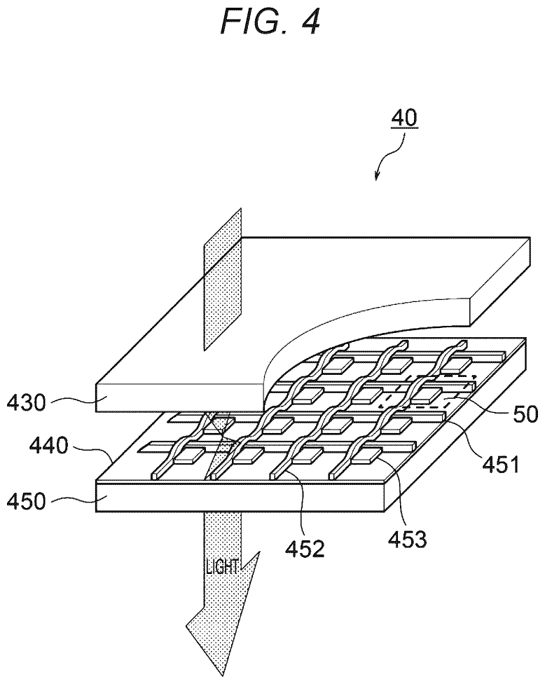

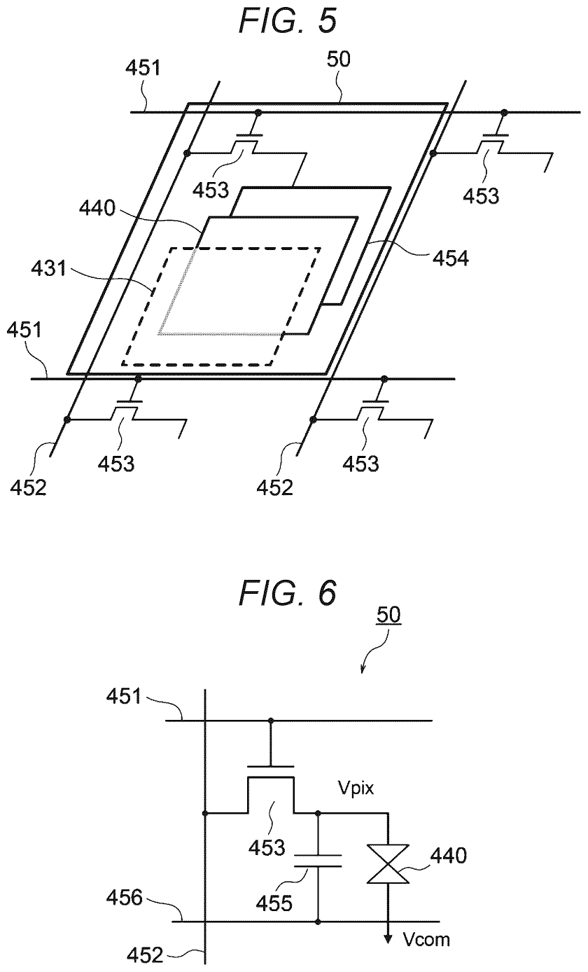

FIG. 4 is a perspective view illustrating structure of a main part of the TFT substrate 450. As illustrated in FIG. 4, in the TFT substrate 450, a plurality of gate lines 451 and a plurality of signal lines 452 are arranged in a lattice pattern. In addition, pixel transistors 453 are disposed in regions surrounded by the gate line 451 and the signal line 452. The pixel transistors 453 are one of constituent elements of pixels 50, and are arranged in a two-dimensional array. Here, the pixel 50 will be described with reference to FIGS. 5 and 6.

FIG. 5 is a schematic diagram illustrating configuration of the pixel 50. In addition, FIG. 6 is an equivalent circuit diagram of the pixel 50.

As illustrated in FIGS. 5 and 6, the pixel 50 includes a pixel transistor 453, a pixel electrode 454 (first electrode), a liquid crystal 440, a counter electrode 431 (second electrode), and a capacitive element 455.

The pixel transistor 453 includes, for example, an n-channel MOS transistor. A gate line 451 is connected to a gate of the pixel transistor 453. A signal line 452 is connected to a drain of the pixel transistor 453. The pixel electrode 454 and the capacitive element 455 are connected to a source of the pixel transistor 453. The pixel electrode 454 and the capacitive element 455 are provided on the TFT substrate 450. The liquid crystal 440 is sandwiched between the pixel electrode 454 and the counter electrode 431. The counter electrode 431 is formed on the counter substrate 430 using a transparent material such as indium tin oxide (ITO). The capacitive element 455 is connected in parallel with the liquid crystal 440.

In the pixel 50 configured as described above, the pixel transistor 453 is turned on and off according to a voltage level of the panel control signal input to the gate from the gate line 451. When the pixel transistor 453 is turned on, a pixel signal Vpix input from the signal line 452 is written in the pixel electrode 454 at a predetermined timing. Note that the pixel signal Vpix is a voltage signal based on a digital video signal. Therefore, a potential of the pixel electrode 454 is set to a voltage indicated by the pixel signal Vpix.

The pixel signal Vpix at the voltage level written in the pixel electrode 454 is held with the counter electrode 431 for a certain period of time. A common potential Vcom (see FIG. 6) is applied to the counter electrode 431.

In the liquid crystal 440, alignment and order of a molecular assembly change depending on a level of a potential difference between the pixel electrode 454 and the counter electrode 431. As a result, the liquid crystal 440 modulates light and enables gradation display. The transmittance of the liquid crystal 440 of each pixel 50 changes according to the voltage of the pixel signal Vpix applied to the pixel electrode 454. As a result, the liquid crystal panel 40 emits light having a contrast corresponding to the pixel signal Vpix.

In the pixel 50, the capacitive element 455 is added in parallel with a liquid crystal capacitance formed between the pixel electrode 454 and the counter electrode 431 in order to prevent the held pixel signal Vpix from being leaked. As a result, holding characteristics are further improved, and the liquid crystal panel 40 having a high contrast ratio can be achieved.

In addition, in order to form the capacitive element 455, a common wiring 456 having resistance is provided. The common potential Vcom is applied to the common wiring 456. The liquid crystal display device 1 according to the present embodiment is configured as, for example, an active matrix liquid crystal display element that performs frame inversion driving of inverting the voltage of the pixel signal Vpix applied to each pixel electrode 454 with respect to the common potential Vcom, which is a counter electrode voltage, for each frame. Here, methods of driving the liquid crystal 440 will be described. Methods of driving the liquid crystal 440 include DC driving and AC driving.

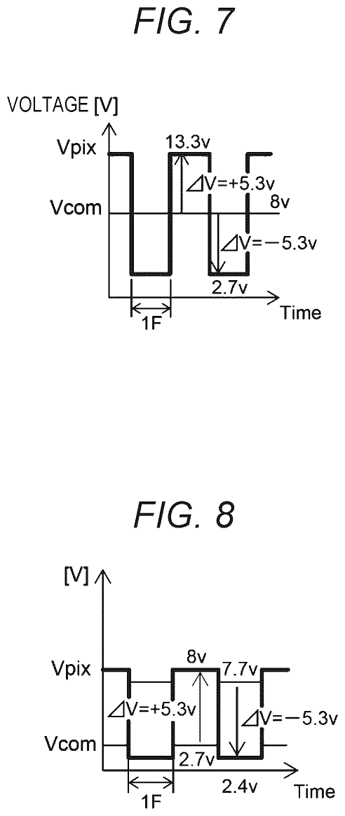

FIG. 7 is a diagram illustrating an example of DC driving of the liquid crystal 440. In FIG. 7, a horizontal axis represents time, and a vertical axis represents the voltage of the pixel signal Vpix and the common potential Vcom. As illustrated in FIG. 7, in the DC driving, the common potential Vcom applied to the counter electrode 431 is set to a fixed value, and the pixel signal Vpix applied to the pixel electrode 454 is increased or decreased with respect to the common potential Vcom. For example, the common potential Vcom is fixed to 8 V, and the pixel signal Vpix is increased or decreased between 13.3 V and 2.7 V. In this case, when 13.3 V is applied to the pixel electrode 454, a difference of 5.3 V is positively applied. On the other hand, when 2.7 V is applied to the pixel electrode 454, a difference of −5.3 V is negatively applied.

FIG. 8 is a diagram illustrating an example of AC driving of the liquid crystal 440. In FIG. 8, a horizontal axis represents time, and a vertical axis represents the pixel signal Vpix and the common potential Vcom. As illustrated in FIG. 8, in the AC driving, the common potential Vcom applied to the counter electrode 431 and the pixel signal Vpix applied to the pixel electrode 454 are varied. For example, when the common potential Vcom is set to 2.7 V and 8.0 V is applied to the pixel electrode 454 as the pixel signal Vpix, a difference of 5.3 V is positively applied. When the common potential Vcom is set to 7.7 V and 2.4 V is applied to the pixel electrode 454 as the pixel signal Vpix, on the other hand, a difference of −5.3 V is negatively applied.

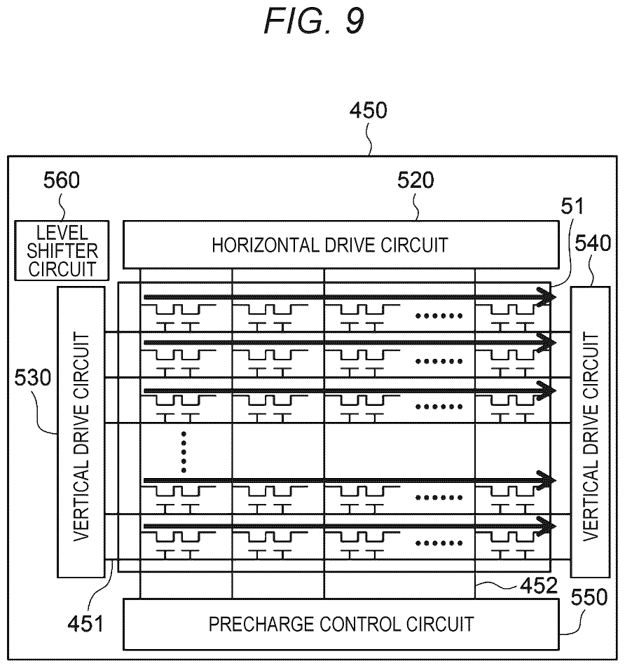

The TFT substrate 450 will be described hereinafter with reference to FIG. 9. FIG. 9 is a diagram illustrating an example of a circuit layout of the TFT substrate 450. As illustrated in FIG. 9, an effective pixel region 51 is disposed at the center of TFT substrate 450. In the effective pixel region 51, the pixels 50 are arranged in a two-dimensional array (matrix). In addition, a horizontal drive circuit 520, vertical drive circuits 530 and 540, a precharge control circuit 550, and a level shifter circuit 560 are arranged around the effective pixel region 51.

The vertical drive circuits 530 and 540 are connected to the effective pixel region 51 via the gate lines 451. In addition, the horizontal drive circuit 520 and the precharge control circuit 550 are connected to the effective pixel region 51 via the signal lines 452.

In the TFT substrate 450 illustrated in FIG. 9, these peripheral circuits arranged around the effective pixel region 51 sequentially write the pixel signal Vpix based on the panel video signal to each pixel 50 in the effective pixel region 51. As a result, the effective pixel region 51 displays an image pattern based on the panel video signal. At this time, when the effective pixel region 51 displays a fixed pattern, an image sticking phenomenon of the liquid crystal 440 can occur. Here, the image sticking phenomenon of the liquid crystal 440 will be described.

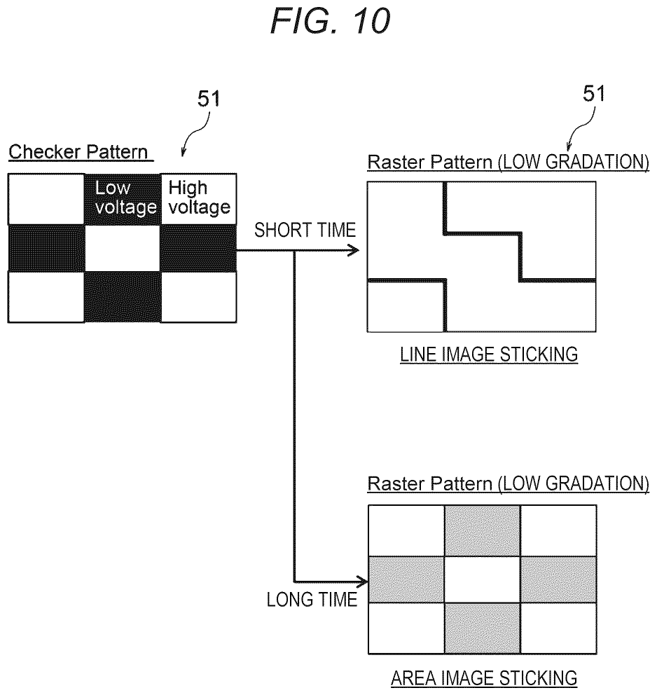

FIG. 10 is a diagram for explaining the image sticking phenomenon of the liquid crystal 440. As illustrated in FIG. 10, for example, it is assumed that the effective pixel region 51 displays a checker pattern in which pixels 50 of white display and pixels 50 of black display are alternately arranged as a fixed pattern. In this case, when the effective pixel region 51 displays the checker pattern for a short period of time of, for example, about 10 minutes and then displays a raster pattern in which all the pixels 50 are displayed in white, a line image sticking phenomenon might occur. The line image sticking phenomenon is a phenomenon in which boundaries between the pixels 50 of white display and the pixels 50 of black display in the checker pattern remain in the raster pattern.

In addition, when the effective pixel region 51 displays the checker pattern for a long period of time and then displays the raster pattern, an area image sticking phenomenon might occur. The area image sticking phenomenon is a phenomenon in which a checker pattern remains in a raster pattern. Here, a cause of occurrence of each of the line image sticking phenomenon and the area image sticking phenomenon will be described.

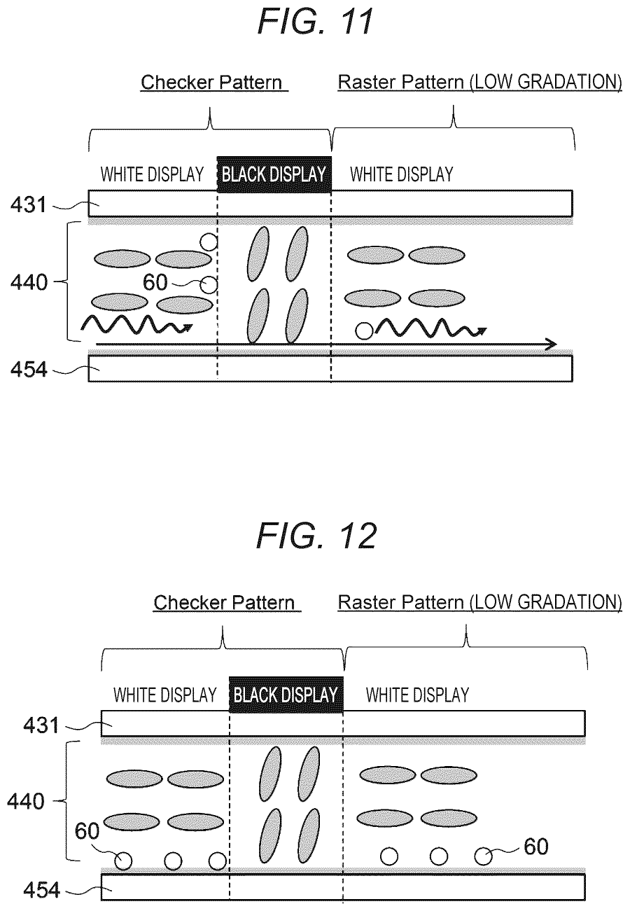

FIG. 11 is a diagram for explaining the cause of occurrence of the line image sticking phenomenon. In each white display pixel 50, a voltage difference is caused between the pixel electrode 454 and the counter electrode 431. In each black display pixel 50, on the other hand, a voltage difference is not caused between the pixel electrode 454 and the counter electrode 431. When the checker pattern is displayed for a short period of time, impurity ions 60 present in the liquid crystal 440 move in an alignment direction of the liquid crystal 440. As a result, the impurity ions 60 stay at the boundaries between the white display pixels 50 and the black display pixels 50, and the line image sticking phenomenon occurs.

FIG. 12 is a diagram for explaining the cause of occurrence of the area image sticking phenomenon. As described above, the voltage difference between the pixel electrode 454 and the counter electrode 431 occurs in the white display pixel 50, but does not occur in the black display pixel 50. When the checker pattern is displayed for a long period of time, the impurity ions 60 are attracted and trapped only in one direction of the pixel electrode 454 or the counter electrode 431. As a result, the area image sticking phenomenon occurs.

As described above, the line image sticking phenomenon and the area image sticking phenomenon are generated by the impurity ions 60. Here, a source of the impurity ions 60 will be described with reference to FIG. 13.

FIG. 13 is a cross-sectional perspective view for explaining the source of impurity ions 60. As illustrated in FIG. 13, the impurity ions 60 are classified into initial impurity ions 60a, first subsequent impurity ions 60b, and second subsequent impurity ions 60c. The initial impurity ions 60a are impurity ions mixed into the liquid crystal 440 from an outside in a production line of the liquid crystal panel 40. The first subsequent impurity ions 60b are impurity ions generated by decomposition of the liquid crystal 440 itself due to short wavelengths (blue light). The second subsequent impurity ions 60c are impurity ions that are present in a sealant 490 confining the liquid crystal 440 between the TFT substrate 450 and the counter substrate 430 and that dissolve into the liquid crystal 440.

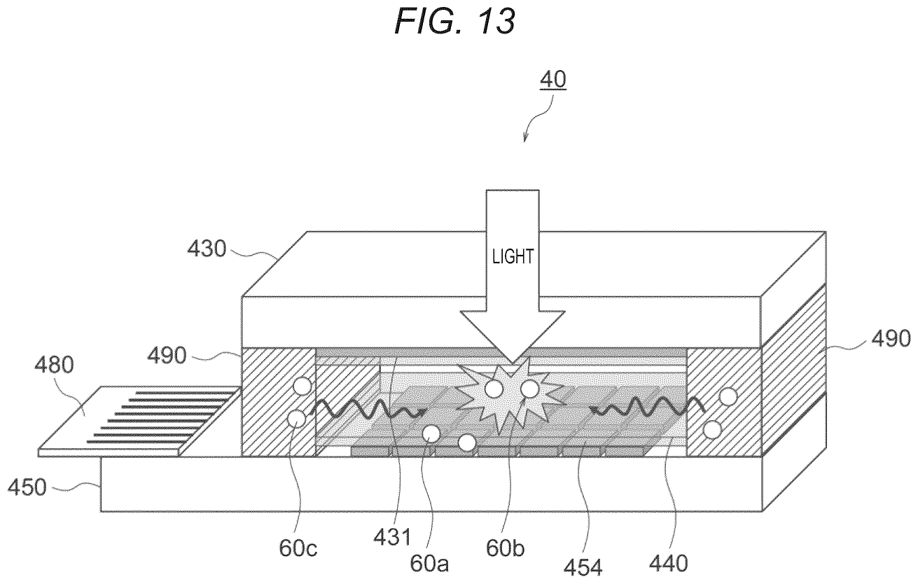

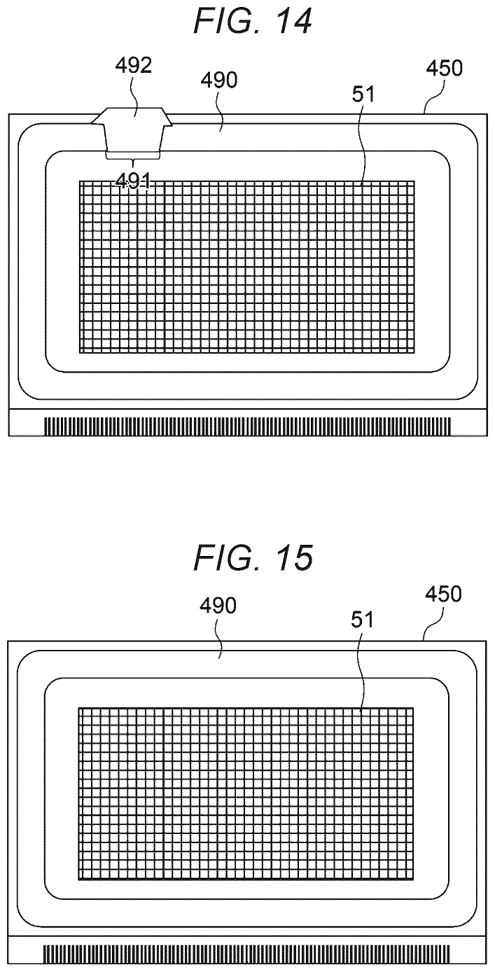

Here, a method of forming the liquid crystal 440 between the TFT substrate 450 and the counter substrate 430 will be described with reference to FIGS. 14 and 15. Here, a liquid crystal injection method and a liquid crystal dropping method will be described.

FIG. 14 is a plan view for explaining the liquid crystal injection method. Note that, in FIG. 14, in order to simplify the drawing, description of the counter substrate 430 and the peripheral circuits such as the horizontal drive circuit 520, the vertical drive circuits 530 and 540, the precharge control circuit 550, and the level shifter circuit 560 illustrated in FIG. 9 is omitted.

In the liquid crystal injection method, first, the sealant 490 is formed on the TFT substrate 450. The sealant 490 is formed in a frame shape surrounding the effective pixel region 51. At this time, the sealant 490 surrounds an entire circumference of the effective pixel region 51 except for an injection port 491. When the sealant 490 is cured, a liquid crystal material is injected into the TFT substrate 450 from the injection port 491 in a vacuum state. Subsequently, the injection port 491 is closed with a plug 492. Finally, the counter substrate 430 is bonded to the TFT substrate 450.

FIG. 15 is a plan view for explaining the liquid crystal dropping method. Note that, also in FIG. 15, in order to simplify the drawing, description of the counter substrate 430 and the peripheral circuits is omitted. In the liquid crystal dropping method, first, the sealant 490 is formed on the TFT substrate 450. However, at this time, since the sealant 490 surrounds the entire circumference of the effective pixel region 51, the injection port 491 is not formed. Subsequently, when the sealant 490 is in an uncured state, the liquid crystal material is dropped, and the TFT substrate 450 and the counter substrate 430 are bonded together in a vacuum state.

In the liquid crystal dropping method, as described above, since the sealant 490 comes into contact with the liquid crystal 440 in the uncured state, the liquid crystal 440 is likely to be contaminated with the second subsequent impurity ions 60c from the sealant 490. Therefore, in the present embodiment, a liquid crystal panel employing the liquid crystal injection method will be described. However, the technology of the present disclosure is also applicable to a liquid crystal panel employing the liquid crystal dropping method.

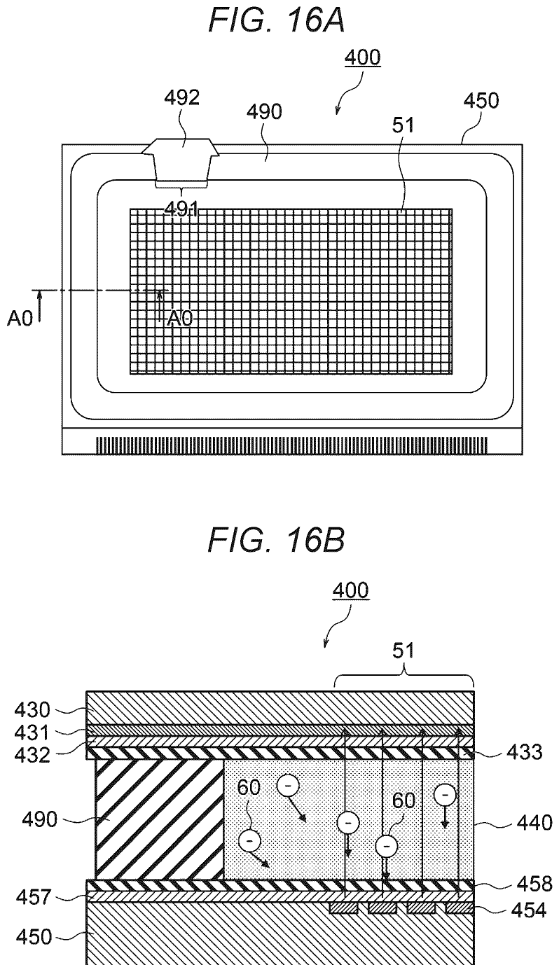

FIG. 16A is a plan view illustrating a schematic structure of a liquid crystal panel according to a comparative example. FIG. 16B is a cross-sectional view taken along section line A0-A0 illustrated in FIG. 16A. As illustrated in FIG. 16B, the counter electrode 431 is formed on a bottom surface of the counter substrate 430 of the liquid crystal panel 400 according to the present comparative example. A second alignment film 432 is formed on a bottom surface of the counter electrode 431. The second alignment film 432 is covered with a second protective film 433. On the other hand, the pixel electrodes 454 are formed on an upper surface of TFT substrate 450. A first alignment film 457 is formed on upper surfaces of the pixel electrodes 454. The first alignment film 457 is covered with a first protective film 458.

The second alignment film 432 and the first alignment film 457 are formed using a porous material such as Sio, for example. In addition, the second protective film 433 and the first protective film 458 are formed using, for example, a material that repels ions and moisture, such as a silane coupling (SC) agent. However, for the convenience of a manufacturing process, it is difficult for the second protective film 433 and the first protective film 458 to completely cover a surfaces of the second alignment film 432 and the first alignment film 457. Therefore, in a case where an electric field is generated between the counter electrode 431 and the pixel electrodes 454 during a display operation of the effective pixel region 51, the impurity ions 60 are attracted and trapped by the second alignment film 432 or the first alignment film 457 according to a polarity thereof. As a result, the image sticking phenomenon occurs.

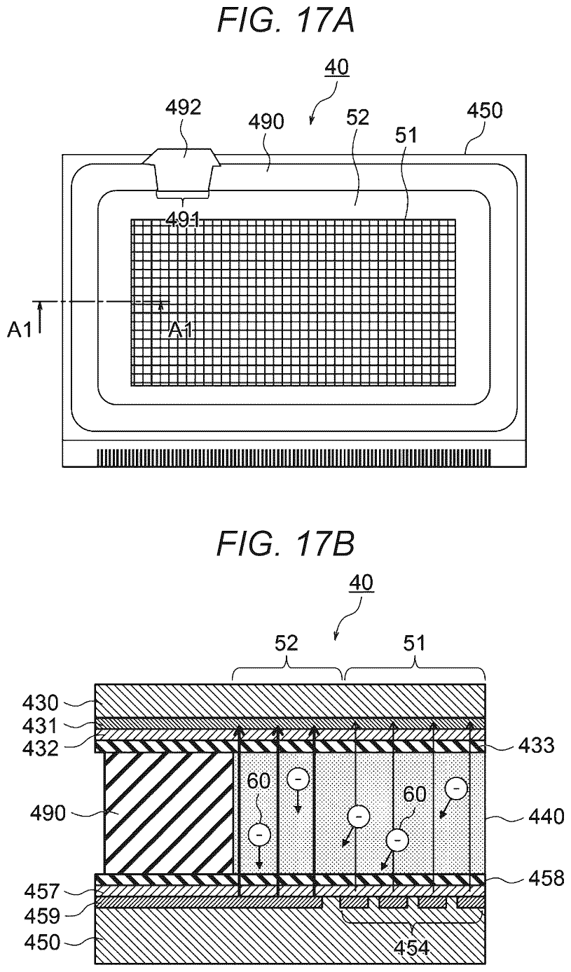

Therefore, an electrode for moving the impurity ions 60 to the outside of the effective pixel region 51 is added to the liquid crystal panel 40 according to the present embodiment. Here, the structure of the liquid crystal panel 40 according to the present embodiment will be described in detail with reference to FIGS. 17A and 17B.

FIG. 17A is a plan view illustrating a schematic structure of the liquid crystal panel 40 according to the first embodiment. In addition, FIG. 17B is a cross-sectional view taken along section line Al-Al illustrated in FIG. 17A. As illustrated in FIG. 17B, in the liquid crystal panel 40 according to the present embodiment, an electrode 459 (third electrode) is newly formed on the TFT substrate 450.

The electrode 459 is formed in the non-effective region 52. Here, the non-effective region 52 is a region between the effective pixel region 51 and the sealant 490, or more strictly, a region between the peripheral circuits of the effective pixel region 51 and the sealant 490. In the present embodiment, the electrode 459 includes the same material as the pixel electrodes 454, and is disposed in the same layer. However, the electrode 459 is disposed away from the pixel electrodes 454, and is electrically insulated from the pixel electrodes 454. Note that, in the present embodiment, the electrode 459 is provided not only in the non-effective region 52 but also below the sealant 490, but may be provided only in the non-effective region 52, instead.

In the liquid crystal panel 40 configured as described above, a voltage is applied to the electrode 459 so that an electric field is generated in the non-effective region 52 when the effective pixel region 51 performs the display operation. Since the electric field is generated in the non-effective region 52, impurity ions 60 present in the non-effective region 52 are attracted to the electrode 459 or the counter electrode 431, and movement to the effective pixel region 51 is restricted. In addition, when electric field intensity of the non-effective region 52 is higher than electric field intensity of the effective pixel region 51, the impurity ions 60 present in the effective pixel region 51 are urged to move to the non-effective region 52. Therefore, trapping of the impurity ions 60 in the non-effective region 52 is promoted. However, the electric field intensity of the non-effective region 52 may be the same as or lower than the electric field intensity of the effective pixel region 51. Furthermore, in the present embodiment, a direction of the electric field of the non-effective region 52 is the same as a direction of an electric field of the effective pixel region 51, but may be opposite thereto.

According to the present embodiment described above, since the electrode 459 promotes the trapping of the impurity ions 60 in the non-effective region 52, the impurity ions 60 in the effective pixel region 51 are reduced as compared with a conventional case. Consequently, the image sticking of the liquid crystal panel 40 hardly occurs, and the deterioration of the display characteristics can be suppressed.

### Second Embodiment

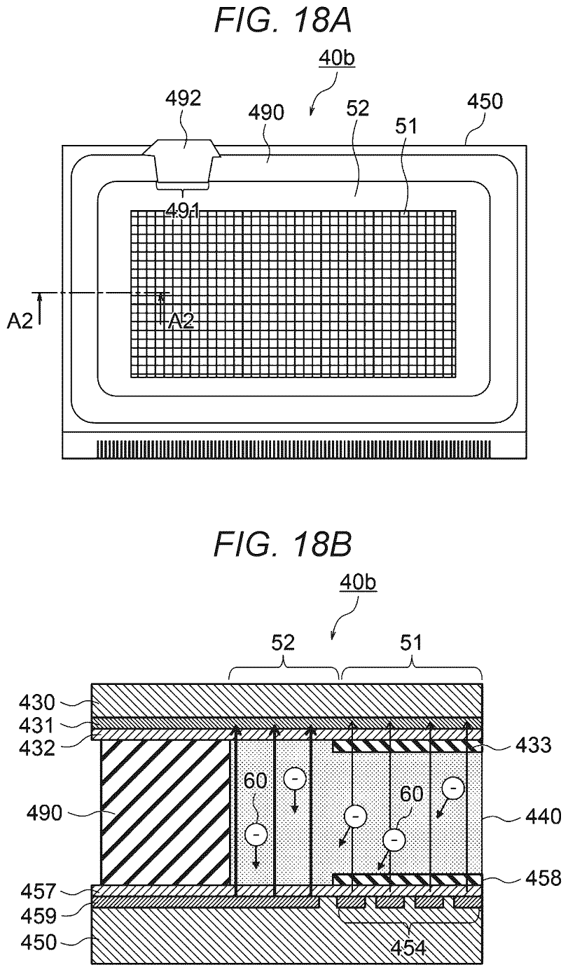

FIG. 18A is a plan view illustrating a schematic structure of a liquid crystal panel according to a second embodiment. In addition, FIG. 18B is a cross-sectional view taken along section line A2-A2 illustrated in FIG. 18A. Here, components similar to those according to the first embodiment described above will be denoted by the same reference signs, and detailed description thereof is omitted.

In the liquid crystal panel 40 according to the first embodiment described above, as illustrated in FIG. 17B, the second protective film 433 and the first protective film 458 are provided in both the effective pixel region 51 and the non-effective region 52.

In a liquid crystal panel 40b according to the present embodiment, on the other hand, as illustrated in FIG. 18B, the second protective film 433 and the first protective film 458 are provided in the effective pixel region 51 and not provided in the non-effective region 52. That is, in the non-effective region 52, the second protective film 433 and the first protective film 458 are removed. Therefore, the second alignment film 432 and the first alignment film 457 are exposed in the non-effective region 52 and in contact with the liquid crystal 440. Note that although both the first alignment film 457 and the second alignment film 432 are exposed in the non-effective region 52 and in contact with the liquid crystal 440 in the present embodiment, only one of these may be exposed in the non-effective region 52 and in contact with the liquid crystal 440, instead. Therefore, it is sufficient that at least one of the first alignment film 457 and the second alignment film 432 is exposed in the non-effective region 52 and in contact with the liquid crystal 440.

The second alignment film 432 and the first alignment film 457 trap the impurity ions 60 more easily than the second protective film 433 and the first protective film 458. Therefore, compared with the first embodiment, the trapping of the impurity ions 60 in the non-effective region 52 is promoted.

Therefore, according to the present embodiment, the impurity ions 60 in the effective pixel region 51 are further reduced. Therefore, it is possible to further suppress deterioration of the display characteristics. Note that roles of the second protective film 433 and the first protective film 458 are to repel the impurity ions 60 and moisture. Therefore, if each protective film is provided at least in the effective pixel region 51, minimum necessary display characteristics can be maintained.

### Third Embodiment

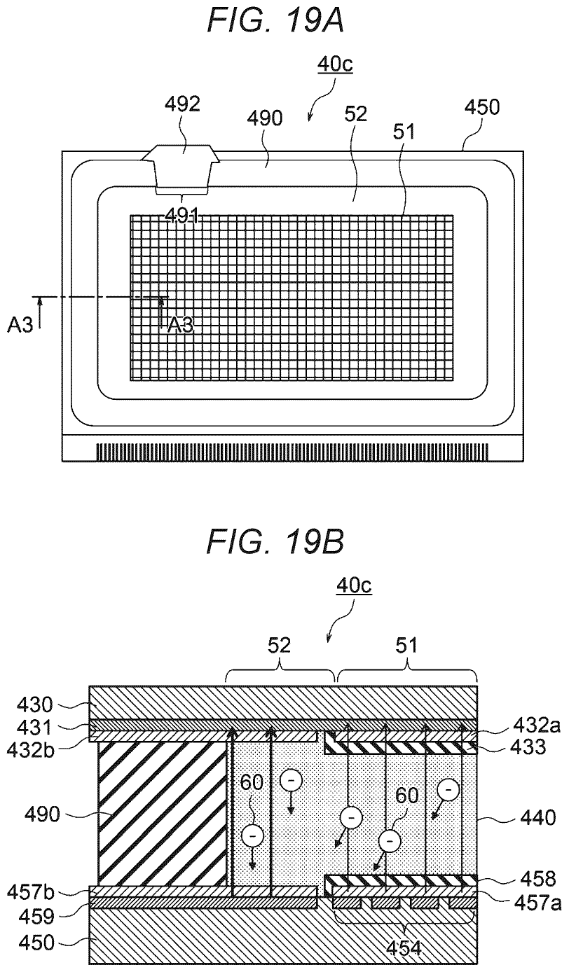

FIG. 19A is a plan view illustrating a schematic structure of a liquid crystal panel according to a third embodiment. In addition, FIG. 19B is a cross-sectional view taken along section line A3-A3 illustrated in FIG. 19A. Here, points different from the above-described second embodiment will be mainly described, and description of similar points is omitted.

In the liquid crystal panel 40b according to the second embodiment described above, as illustrated in FIG. 18B, the second alignment film 432 and the first alignment film 457 continuously extend from the effective pixel region 51 to the non-effective region 52.

On the other hand, on a counter substrate 430 side of the liquid crystal panel 40c according to the present embodiment, as illustrated in FIG. 19B, a second alignment film 432a provided in the effective pixel region 51 and a second alignment film 432b provided in the non-effective region 52 are separated from each other. In addition, the second protective film 433 covers a surface of the second alignment film 432a, specifically, a bottom surface and side surfaces, whereas the second alignment film 432b is not covered with the second protective film 433 and is exposed to be in contact with the liquid crystal 440.

On the other hand, on a TFT substrate 450 side of the liquid crystal panel 40c, a first alignment film 457a provided in the effective pixel region 51 and a first alignment film 457b provided in the non-effective region 52 are separated from each other. In addition, the first protective film 458 covers a surface of the first alignment film 457a, specifically, a bottom surface and side surfaces, whereas the first alignment film 457b is not covered with the first protective film 458 and is exposed to be in contact with the liquid crystal 440.

The second alignment film 432b and the first alignment film 457b trap the impurity ions 60 more easily than the second protective film 433 and the first protective film 458 as described in the second embodiment. Therefore, also in the present embodiment, compared with the first embodiment, the trapping of the impurity ions 60 in the non-effective region 52 is promoted.

Therefore, according to the present embodiment, as in the second embodiment, the impurity ions 60 in the effective pixel region 51 are further reduced. Therefore, it is possible to further suppress deterioration of the display characteristics.

Furthermore, in the present embodiment, the alignment film is separated at a boundary between the effective pixel region 51 and the non-effective region 52, but the second alignment film 432a and the first alignment film 457a provided in the effective pixel region 51 are covered with the second protective film 433 and the first protective film 458 including the side surfaces. Therefore, it is possible to suppress the deterioration of the display characteristics while sufficiently protecting the alignment films provided in the effective pixel region 51.

### Fourth Embodiment

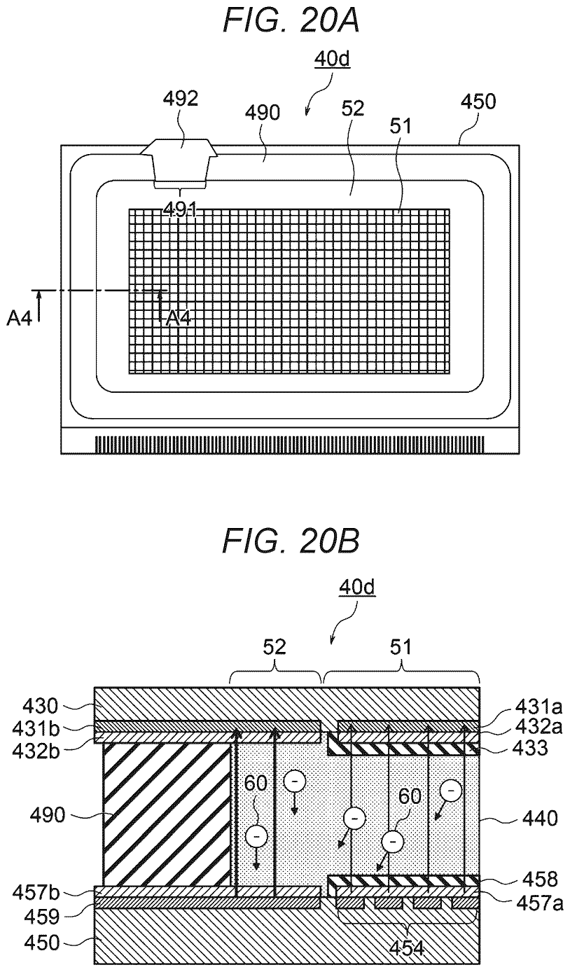

FIG. 20A is a plan view illustrating a schematic structure of a liquid crystal panel according to a fourth embodiment. In addition, FIG. 20B is a cross-sectional view taken along section line A4-A4 illustrated in FIG. 20A. Here, points different from the above-described third embodiment will be mainly described, and description of similar points is omitted.

In the liquid crystal panel 40c according to the third embodiment described above, as illustrated in FIG. 19B, the counter electrode 431 continuously extends from the non-effective region 52 to the non-effective region 52.

On the other hand, in a liquid crystal panel 40d according to the present embodiment, as illustrated in FIG. 20B, a counter electrode 431a provided in the effective pixel region 51 and a counter electrode 431b provided in the non-effective region 52 are separated from each other. Therefore, a voltage different from that of the counter electrode 431a can be applied to the counter electrode 431b. As a result, a degree of freedom in setting the electric field intensity in the non-effective region 52 is improved.

In the liquid crystal panel 40d according to the present embodiment, as in the third embodiment, the second alignment film 432b and the first alignment film 457b provided in the non-effective region 52 are exposed without being covered with the second protective film 433 and the first protective film 458. Consequently, the trapping of the impurity ions 60 in the non-effective region 52 is promoted, so that the impurity ions 60 in the effective pixel region 51 are further reduced as in the third embodiment. As a result, it is possible to further suppress the deterioration of the display characteristics.

Furthermore, in the present embodiment, since the counter electrode is separated at the boundary between the effective pixel region 51 and the non-effective region 52, the electric field intensity in the non-effective region 52 can be set independently of the electric field intensity in the effective pixel region 51. Therefore, in the non-effective region 52, electric field intensity optimal for trapping the impurity ions 60 can be set.

### Fifth Embodiment

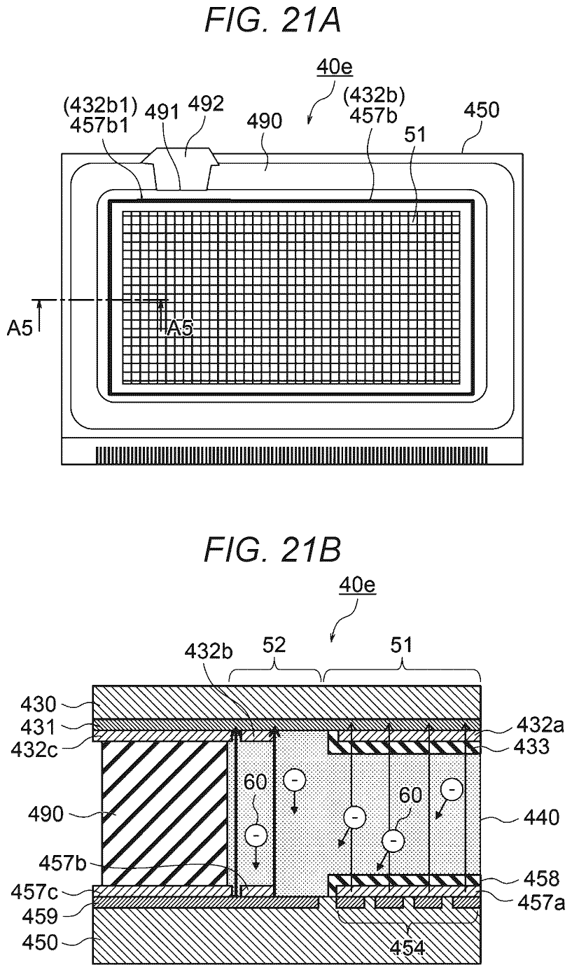

FIG. 21A is a plan view illustrating a schematic structure of a liquid crystal panel according to a fifth embodiment. In addition, FIG. 21B is a cross-sectional view taken along section line A5-A5 illustrated in FIG. 21A. Here, points different from the above-described third embodiment will be mainly described, and description of similar points is omitted.

In the liquid crystal panel 40c according to the third embodiment described above, as illustrated in FIG. 19B, each of the second alignment film 432b and the first alignment film 457b provided in the non-effective region 52 is also in contact with the sealant 490.

On the other hand, in the TFT substrate 450 of the liquid crystal panel 40d according to the present embodiment, as illustrated in FIG. 21B, the first alignment film 457b is separated from the first alignment film 457c in contact with a bottom surface of the sealant 490. At this time, the sealant 490 separates the first alignment film 457b in such a way as not to block the exposure of the first alignment film 457b, which is a part of an ion trapper that traps the impurity ions 60. In addition, as illustrated in FIG. 21A, the first alignment film 457b has a protrusion 457b1 protruding toward the plug 492 at a portion facing the plug 492, which closes the injection port 491 of the liquid crystal 440.

On the other hand, in the counter substrate 430 of the liquid crystal panel 40d, as illustrated in FIG. 21B, the second alignment film 432b is separated from the second alignment film 432c in contact with an upper surface of the sealant 490. At this time, the sealant 490 separates the second alignment film 432b in such a way as not to block the exposure of the second alignment film 432b, which is another part of the ion trapper. In addition, as illustrated in FIG. 21A, the second alignment film 432b has a protrusion 432b1 protruding toward the plug 492 at a portion facing the plug 492, which closes the injection port 491.

In a liquid crystal panel 40e according to the present embodiment configured as described above, the second alignment film 432b and the first alignment film 457b are exposed and in contact with the liquid crystal 440. Therefore, compared with the first embodiment, the trapping of the impurity ions 60 in the non-effective region 52 is promoted.

Therefore, according to the present embodiment, the impurity ions 60 in the effective pixel region 51 are further reduced. Therefore, it is possible to further suppress deterioration of the display characteristics.

In addition, in the liquid crystal panel 40e, when moisture in an external environment enters the liquid crystal 440 through the sealant 490 or the plug 492, deterioration occurs due to a vertical electric field (VT) characteristic shift or leakage between adjacent pixels. An alignment film including a porous material is effective for trapping moisture.

Therefore, in the present embodiment, the second alignment film 432b and the first alignment film 457b are exposed without being covered with the second protective film 433 and the first protective film 458 in the non-effective region 52 located between the effective pixel region 51 and the sealant 490. As a result, the second alignment film 432b and the first alignment film 457b, which are porous films, function not only as an ion trap but also as a moisture trap. In addition, the second alignment film 432b and the first alignment film 457b have protrusions 432b1 and 457b1 at the portions facing the plug 492. As a result, area of each alignment film is increased in the vicinity of the plug 492 into which moisture easily enters, so that the function of moisture trap is enhanced. Therefore, it is possible to enhance the effect of preventing moisture from entering the effective pixel region 51.

Furthermore, in the present embodiment, the sealant 490 is in contact with the alignment film as in the other embodiments. If the sealant 490 has a structure in contact with the counter substrate 430 and the electrode 459, the sealant 490 might be repelled and adhesion force might be insufficient. However, in the present embodiment, since the sealant 490 is in contact with the second alignment film 432c and the first alignment film 457c, adhesion can be sufficiently secured. In addition, width of the sealant 490 can also be defined by the second alignment film 432c and the first alignment film 457c.

### Sixth Embodiment

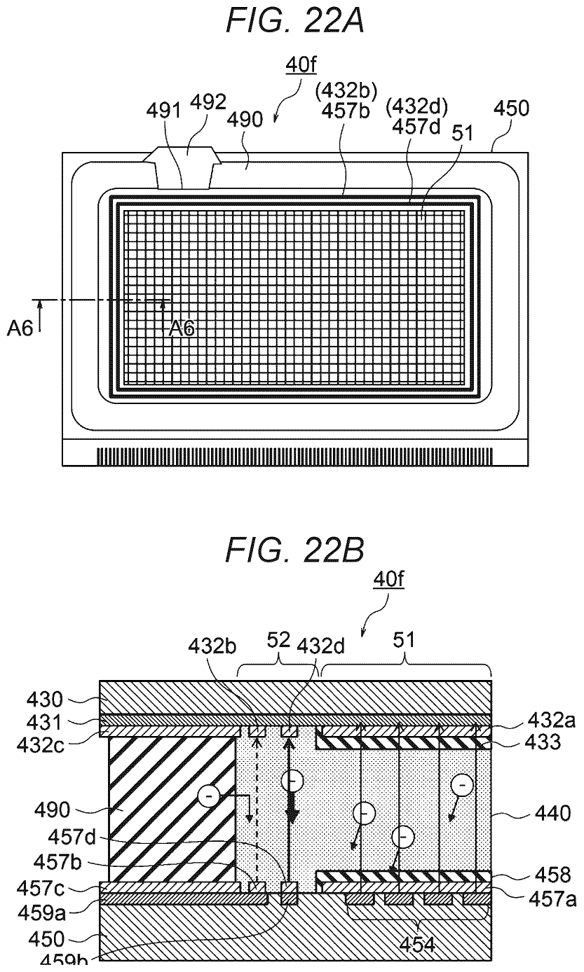

FIG. 22A is a plan view illustrating a schematic structure of a liquid crystal panel according to a sixth embodiment. In addition, FIG. 22B is a cross-sectional view taken along section line A6-A6 illustrated in FIG. 22A. Here, points different from the above-described fifth embodiment will be mainly described, and description of similar points is omitted.

In the liquid crystal panel 40e according to the fifth embodiment described above, as illustrated in FIG. 21B, each of the second alignment film 432b and the first alignment film 457b provided in the non-effective region 52 surrounds the effective pixel region 51 with a single layer.

On the other hand, in a liquid crystal panel 40f according to the present embodiment, as illustrated in FIG. 22B, a plurality of alignment films in the non-effective region 52 surrounds the effective pixel region 51 with multiple layers. Specifically, in the TFT substrate 450, a first alignment film 457b and a first alignment film 457d are provided in the effective pixel region 51. The first alignment film 457b is disposed on a sealant 490 side. The first alignment film 457d is disposed on an effective pixel region 51 side. An electrode 459a is in contact with a bottom surface of the first alignment film 457b. An electrode 459b is in contact with a bottom surface of the first alignment film 457d. The electrode 459b is separated from the electrode 459a.

In addition, in the counter substrate 430, a second alignment film 432b and a second alignment film 432d are provided in the effective pixel region 51. The second alignment film 432b is disposed on the sealant 490 side and faces the first alignment film 457b. The second alignment film 432d is disposed on the effective pixel region 51 side and faces the first alignment film 457d.

In the liquid crystal panel 40f according to the present embodiment configured as described above, the second alignment film 432b and the first alignment film 457b are exposed and in contact with the liquid crystal 440. Therefore, each alignment film not only functions as an ion trap that traps the impurity ions 60 eluted from the sealant 490, but also functions as a moisture trap that traps moisture entering from the plug 490 and the plug 492. Note that the second alignment film 432b and the first alignment film 457b may be provided with the protrusions 432b1 and 457b1 described in the fifth embodiment. In this case, the function of trapping moisture entering from the plug 492 can be enhanced. In addition, the second alignment film 432d and the first alignment film 457d function as an ion trap that traps the impurity ions 60 generated in the effective pixel region 51.

Electric field intensity applied between the second alignment film 432b and the first alignment film 457b, electric field intensity applied between the second alignment film 432d and the first alignment film 457d, and size of these first alignment films 457 are appropriately set according to an application (function) of the liquid crystal panel 40f and a generation state of the impurity ions 60. Therefore, for example, in a case where the impurity ions 60 generated in the effective pixel region 51 are more than the impurity ions 60 eluted from the sealant 490, the electric field intensity applied between the second alignment film 432d and the first alignment film 457d is set higher than the electric field intensity applied between the second alignment film 432b and the first alignment film 457b.

According to the present embodiment described above, by forming multiple trap structures of the impurity ions 60 in the non-effective region 52, the electric field intensity and the size of the alignment films can be appropriately set according to a generation location and a penetration location of the impurity ions 60. Therefore, it is possible to further suppress deterioration of the display characteristics.

### Seventh Embodiment

A seventh embodiment of the present disclosure will be described. Here, first, a general method of driving the pixels 50 will be described.

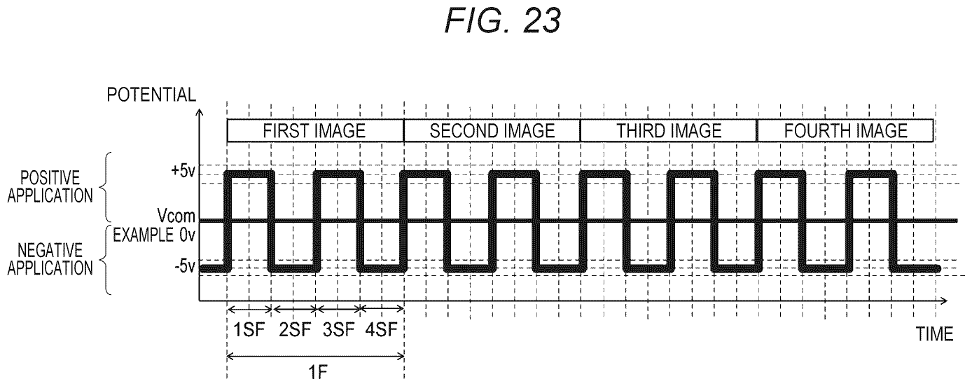

FIG. 23 is a waveform diagram of the pixel signal Vpix. As illustrated in FIG. 23, the signal processing circuit 20 writes one display image in the pixels 50 four times. That is, the pixels 50 display one display image in each of four subfield (SF) periods. Each SF period is a time obtained by dividing a 1F (field) period into four equal parts. Time of 1F is, for example, 60 Hz (16.7 ms).

When a voltage higher than the potential Vcom of the counter electrode 431 is applied to the pixel electrodes 454, positive application is performed. Conversely, when a voltage lower than the potential Vcom of the counter electrode 431 is applied to the pixel electrodes 454, negative application is performed. In the case of the positive application, positive impurity ions 60 move toward the counter electrode 431, and negative impurity ions 60 move toward the pixel electrodes 454. In the case of the negative application, on the other hand, positive impurity ions 60 move toward the pixel electrodes 454, and negative impurity ions 60 move toward the counter electrode 431. Therefore, when a display image is written to the pixels 50, the impurity ions 60 are less likely to be biased to the counter substrate 430 side or the TFT substrate 450 side by alternately repeating the positive application and the negative application.

Next, raster display of a liquid crystal panel according to a seventh embodiment will be described. Here, white raster display, in which all the pixels 50 are displayed in white, will be described.

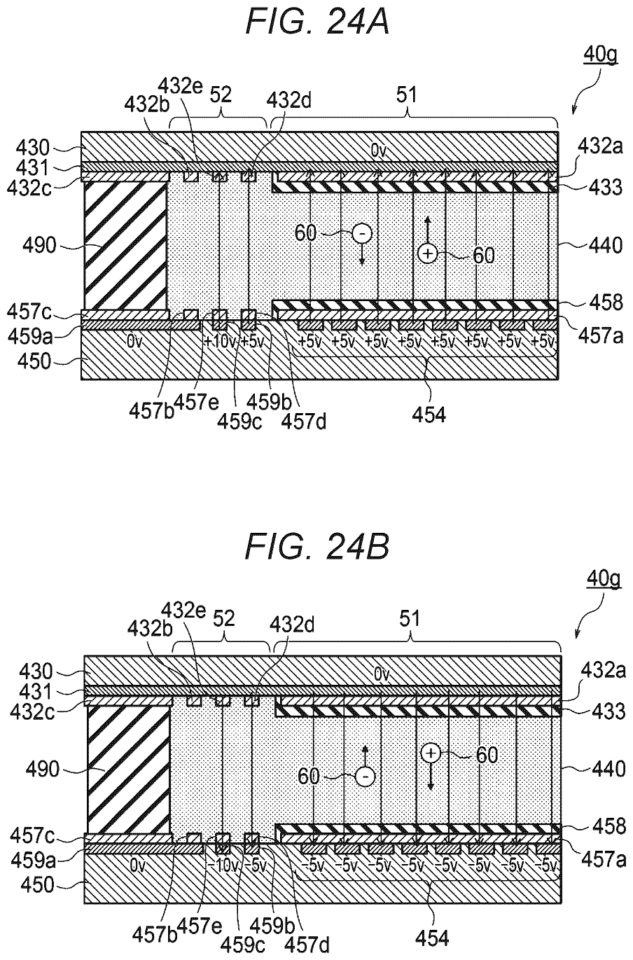

FIG. 24A is a cross-sectional view illustrating a state inside the liquid crystal 440 at a time when the white raster display with the positive application is performed in a liquid crystal panel 40g according to the seventh embodiment. In addition, FIG. 24B is a cross-sectional view illustrating a state inside the liquid crystal 440 at a time when the white raster display with the negative application is performed in the liquid crystal panel 40g according to the seventh embodiment.

In the positive application, when a voltage as illustrated in FIG. 24A is applied to each of the counter electrode 431, the pixel electrodes 454, and electrodes 459a to 459c, a direction of a vertical electric field becomes an upward direction from the TFT substrate 450 toward the counter substrate 430. In the negative application, when a voltage as illustrated in FIG. 24B is applied to each electrode, the direction of the vertical electric field becomes a downward direction from the counter substrate 430 from the TFT substrate 450 toward the counter substrate 430.

However, in both the positive application and the negative application, the potential of the pixel electrodes 454 is the same. Therefore, a lateral electric field is not generated in the effective pixel region 51. As a result, the impurity ions 60 do not move in a lateral direction from the effective pixel region 51 toward the non-effective region 52.

Next, ramp display of the liquid crystal panel 40g according to the seventh embodiment will be described. The ramp display is a display in which gradation from white display to black display exists in the effective pixel region 51.

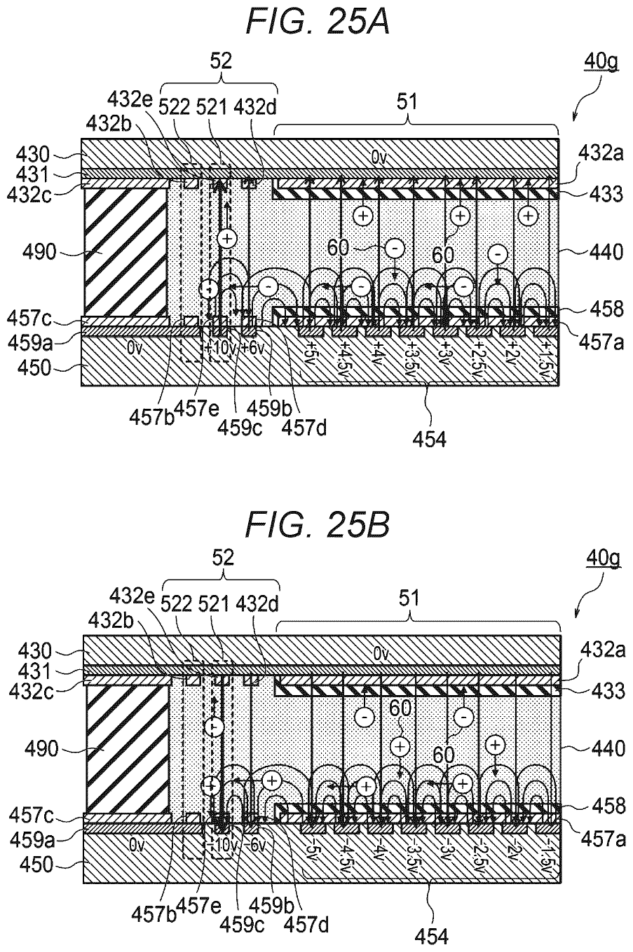

FIG. 25A is a cross-sectional view illustrating a state inside the liquid crystal 440 at a time when the ramp display with the positive application is performed in the liquid crystal panel 40g according to the seventh embodiment. In addition, FIG. 25B is a cross-sectional view illustrating a state inside the liquid crystal 440 at a time when the ramp display with the negative application is performed in the liquid crystal panel 40g according to the seventh embodiment.

In the positive application, when a voltage as illustrated in FIG. 25A is applied to each of the counter electrode 431, the pixel electrodes 454, and the electrodes 459a to 459c, the direction of the vertical electric field becomes the upward direction. In the negative application, when a voltage as illustrated in FIG. 25B is applied to each electrode, the direction of the vertical electric field becomes the downward direction.

In the ramp display, the impurity ions 60 move faster toward the TFT substrate 450 with a strong vertical electric field (high gradation). Therefore, in the positive application, negative impurity ions 60 are attracted toward the TFT substrate 450, and positive impurity ions 60 are attracted toward the counter substrate 430. In the negative application, on the other hand, positive impurity ions 60 are attracted toward the TFT substrate 450, and negative impurity ions 60 are attracted toward the counter substrate 430.

In addition, in the ramp display, since a potential difference is caused between the pixel electrodes 454, a lateral electric field is generated. Therefore, the impurity ions 60 move in the lateral direction from a pixel 50 of low-gradation display toward a pixel 50 of high-gradation display. Specifically, in the positive application, negative impurity ions 60 move in the lateral direction, and in the negative application, positive impurity ions 60 move in the lateral direction.

In the non-effective region 52, a high vertical electric field is generated in a region 521 where the electrode 459c and the counter electrode 431 face each other. Therefore, the region 521 becomes an ion trap region in which the positive and negative impurity ions 60 are retained or trapped in a first alignment film 457e. In the region 521, an outflow of the impurity ions 60 can be suppressed by setting intensity of the vertical electric field to be higher than intensity of the lateral electric field.

In addition, in the non-effective region 52, in a region 522 where the electrode 459a and the counter electrode 431 face each other, the high vertical electric field is not generated because the electrode 459a and the counter electrode 431 have the same potential (0 V). Therefore, the region 522 is a black display region. In the black display region, moving speed of the impurity ions 60 greatly decreases, so that the region 522 serves as an ion wall. As a result, the impurity ions 60 eluted from the sealant 490 can be suppressed from entering the effective pixel region 51.

In order to move the impurity ions 60 at a higher speed, a pattern utilizing a property that the impurity ions 60 move in an alignment direction (chiral direction) of the liquid crystal 440 is advantageous. Therefore, it is desirable to align an alignment direction on the TFT substrate 450 side (a direction in which the lateral electric field is strong due to fluctuation of liquid crystal molecules) and the lateral electric field by the pattern for moving the impurity ions 60. However, it is preferable not to use black display for this pattern. This is because the black display slows down the moving speed of the impurity ions 60.

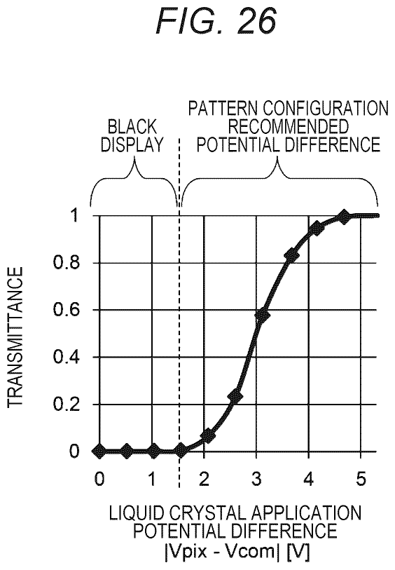

FIG. 26 is a diagram illustrating an example of VT characteristics of the liquid crystal 440. In FIG. 26, a horizontal axis represents a potential difference applied to the liquid crystal 440, and a vertical axis represents transmittance of the liquid crystal 440. According to FIG. 26, the pattern for moving the impurity ions 60 is desirably formed by a vertical electric field of 2 V or more.

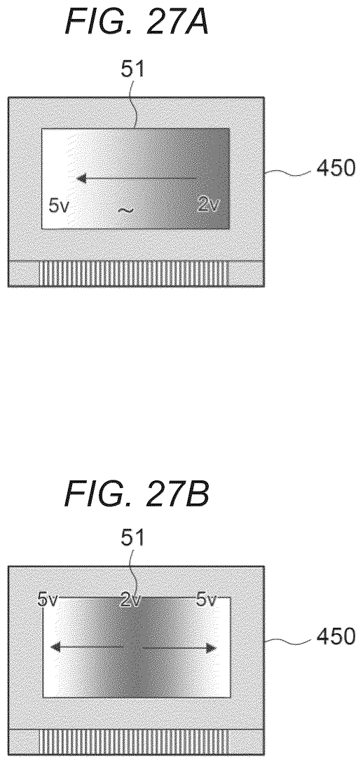

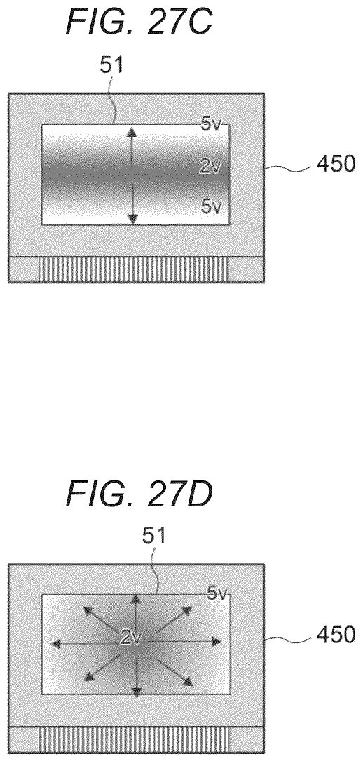

FIGS. 27A to 27D are plan views illustrating examples of a pattern of a still image displayed by refresh driving for moving the impurity ions 60. Note that, in the present disclosure, the pattern of the still image is not limited to the patterns illustrated in FIGS. 27A to 27D as long as the pattern generates a lateral electric field.

FIG. 27A illustrates a basic pattern. In the basic pattern, a potential difference between a pixel electrode 454 disposed at a right end, which is one end of the effective pixel region 51 in a lateral direction, and the counter electrode 431 is 2 V, and a potential difference between a pixel electrode 454 disposed at a left end, which is another end in the lateral direction, and the counter electrode 431 is 5 V. Potential differences between the right end and the left end of the effective pixel region 51 are set within a range from a value larger than 2 V to a value smaller than 5 V according to the number of pixels in the lateral direction.

FIG. 27B illustrates a left-right division pattern. In the left-right division pattern, a potential difference between a pixel electrode 454 disposed at the center of the effective pixel region 51 and the counter electrode 431 is 2 V, and potential differences between pixel electrodes 454 disposed at the left and right ends and the counter electrode 431 are 5 V. Potential differences between the center and the right or left end of the effective pixel region 51 are set within a range from a value larger than 2 V to a value smaller than 5 V according to the number of pixels in the lateral direction.

FIG. 27C illustrates a top-bottom division pattern. In the top-bottom division pattern, a potential difference between a pixel electrode 454 disposed at the center of the effective pixel region 51 and the counter electrode 431 is 2 V, and potential differences between pixel electrodes 454 disposed at a top and a bottom and the counter electrode 431 are 5 V. Potential differences between the center and the top or bottom of the effective pixel region 51 are set within a range from a value larger than 2 V to a value smaller than 5 V according to the number of pixels in a vertical direction (first direction).

FIG. 27D illustrates a radial pattern. In the radial pattern, a potential difference between a pixel electrode 454 disposed at the center of the effective pixel region 51 and the counter electrode 431 is 2 V, and potential differences between pixel electrodes 454 disposed at peripheral ends, which are top, bottom, left, and right ends, of the effective pixel region 51 and the counter electrode 431 are 5 V. Potential differences between the center and the peripheral ends of the effective pixel region 51 are set within a range from a value larger than 2 V to a value smaller than 5 V according to the number of pixels in a radial direction.

In the still image patterns shown in FIGS. 27A to 27D, gradation of voltage differences is set in the pixels 50 within a range of 2 V to 5 V in order to generate a lateral electric field. Therefore, if the number of pixels is large, the lateral electric field becomes weak. If the lateral electric field is weak, the moving speed of the impurity ions 60 decreases, so that it takes time to trap the ions. It is desirable that the refresh driving that is spontaneously executed by the user when image sticking of the liquid crystal 440 occurs and refresh driving that automatically moves the impurity ions 60 in the effective pixel region 51 to the non-effective region 52 at a time of activation be performed in a short time.

In order to perform refresh driving in a short time, application of a strong lateral electric field is effective. As a method of applying a strong lateral electric field, it is conceivable to reduce the number of pixels to be subjected to the voltage gradation of 2 V to 5 V. This is enabled by using a moving image. For example, scrolling is performed from a low gradation (2 V) to a high gradation (5 V).

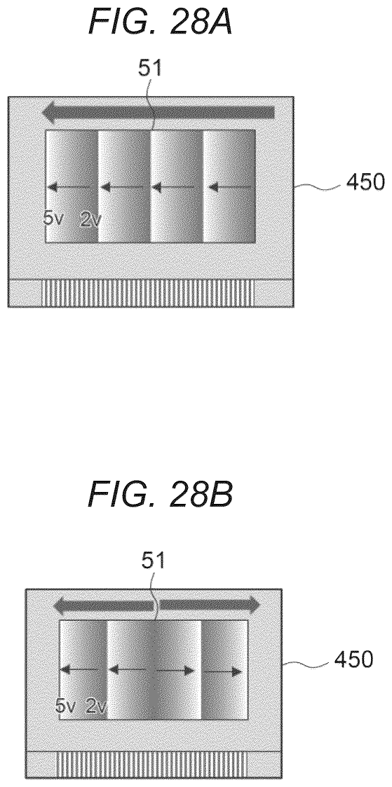

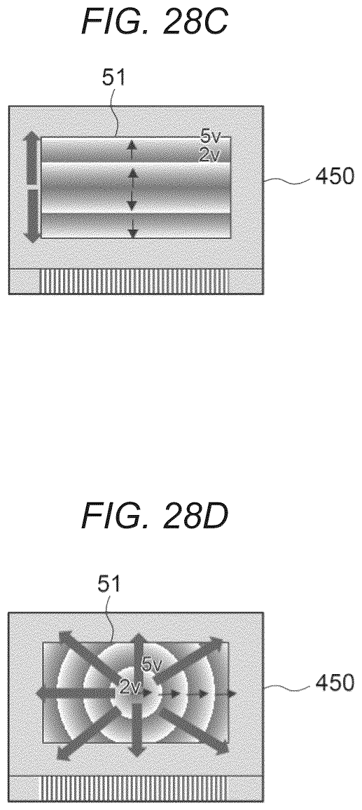

FIGS. 28A to 28D are plan views illustrating examples of a pattern of a moving image displayed by refresh driving for moving the impurity ions 60.

FIG. 28A illustrates a basic pattern. In the basic pattern, a voltage gradation of 2 V to 5 V is set in the pixels 50 in the effective pixel region 51. At this time, the number of pixels constituting the voltage gradation is smaller than the number of pixels constituting the basic pattern of the still image. In addition, in the basic pattern, the voltage gradation of 2 V to 5 V is set to scroll in the lateral direction (second direction) from the left end to the right end of the effective pixel region 51.

FIG. 28B illustrates a left-right division pattern. In the left-right division pattern, too, the voltage gradation of 2 V to 5 V is set in the pixels 50. At this time, the number of pixels constituting the voltage gradation is smaller than the number of pixels constituting the left-right division pattern of the still image. In addition, in the left-right division pattern, the voltage gradation of 2 V to 5 V is set to scroll in the lateral direction from the center to the left and right ends of the effective pixel region 51.

FIG. 28C illustrates a top-bottom division pattern. In the top-bottom division pattern, too, the voltage gradation of 2 V to 5 V is set in the pixels 50 in the effective pixel region 51. At this time, the number of pixels constituting the voltage gradation is smaller than the number of pixels constituting the top-bottom division pattern of the still image. In addition, in the top-bottom division pattern, the voltage gradation of 2 V to 5 V is set to scroll in the vertical direction from the center to the top and the bottom of the effective pixel region 51.

FIG. 28D illustrates a radial pattern. In the radial pattern, too, the voltage gradation of 2 V to 5 V is set in the pixels 50 in the effective pixel region 51. At this time, the number of pixels constituting the voltage gradation is smaller than the number of pixels constituting the radial pattern of the still image. In addition, in the radial pattern, the voltage gradation of 2 V to 5 V is set to scroll radially from the center of the effective pixel region 51.

Since the display patterns illustrated in FIGS. 28A to 28D are display images for refresh driving, it is desirable not to show the display patterns to the user. Therefore, the pattern display illustrated in FIGS. 28A to 28D is desirably executed, for example, in a state where a light source is turned off.

In addition, in a case where the impurity ions 60 are subsequent impurity ions, there is wavelength dependency where the liquid crystal 440 is decomposed at shorter wavelengths. Therefore, in a liquid crystal display device in which the liquid crystal panel 40g is separately provided for each of red light, green light, and blue light, liquid crystal decomposition is most likely to occur in the liquid crystal panel 40g for blue light. Therefore, the liquid crystal panel 40g for blue light may have a higher frequency of the refresh driving or a higher lateral electric field intensity than the liquid crystal panels 40g for red light and green light.

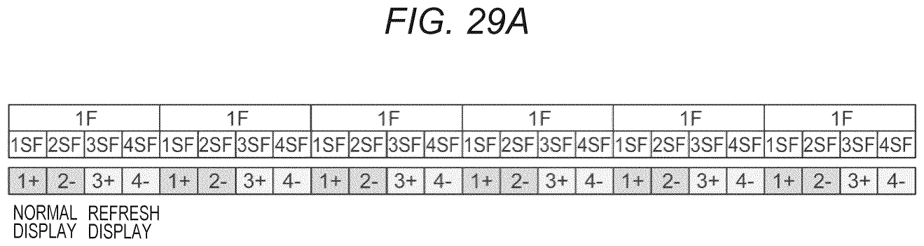

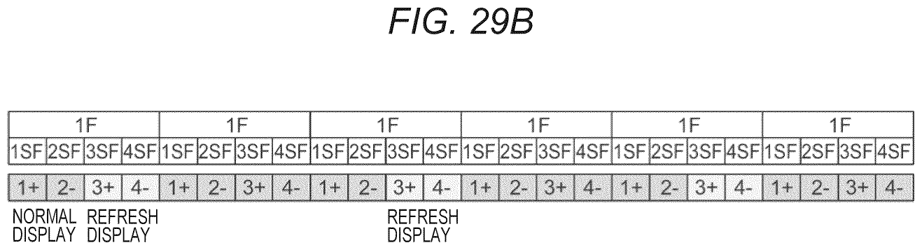

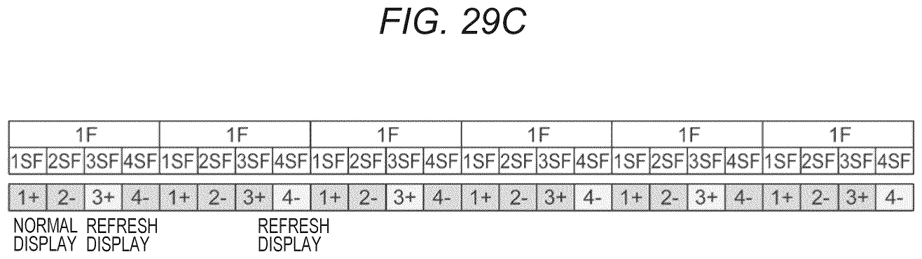

FIG. 29A is a diagram illustrating an example of image display timings of the liquid crystal panel 40g according to the seventh embodiment. In FIGS. 29A, 1F (field) corresponds to 60 Hz. In the present embodiment, 1F is divided into four SFs (subfields).

In a first subfield (1SF), the liquid crystal panel 40g performs normal display of displaying a positive-application image based on a video signal. In a second subfield (2SF) following the first subfield (1SF), the liquid crystal panel 40g performs normal display of displaying a negative-application image based on a video signal.

In a third subfield (3SF) following the second subfield (2SF), the liquid crystal panel 40g performs refresh display of displaying a pattern of a still image with positive application (see FIGS. 27A to 27D) or a pattern of a moving image with positive application (FIGS. 28A to 28D). In a fourth subfield (4SF) following the third subfield (3SF), the liquid crystal panel 40g performs refresh display of displaying a pattern of a still image with negative application or a pattern of a moving image with negative application.

At the image display timings illustrated in FIG. 29A, the refresh display is temporally overlapped with the normal display, so that there is a concern about degradation of displayed images. Therefore, the liquid crystal panel 40g may execute the image display at timings illustrated in FIG. 29B or 29C, for example.

FIG. 29B is a diagram illustrating a first modification of the image display timings of the liquid crystal panel 40g according to the seventh embodiment. In FIG. 29B, the liquid crystal panel 40g performs the refresh display in a first field, does not perform the refresh display in a second field, and performs the refresh display again in a third field. That is, the liquid crystal panel 40g performs the refresh display every other image display unit. In this case, since the frequency of the refresh display is lower than that of the image display illustrated in FIG. 29A, it is possible to make the refresh display inconspicuous.

FIG. 29C is a diagram illustrating a second modification of the image display timings of the liquid crystal panel 40g according to the seventh embodiment. In FIG. 29C, the liquid crystal panel 40g performs the refresh display only in a third subfield in a first field, and performs the refresh display only in a fourth subfield in a second field. That is, the liquid crystal panel 40g performs the refresh display in two image display units (fields). In this case, too, since the frequency of the refresh display is lower than that of the image display illustrated in FIG. 29A, it is possible to make the refresh display inconspicuous.

According to the present embodiment described above, the image sticking of the liquid crystal 440 in the effective pixel region 51 is less likely to occur by performing the refresh driving for prompting the impurity ions 60 present in the effective pixel region 51 to move to the non-effective region 52. As a result, the deterioration of the display characteristics can be suppressed.

Furthermore, in the present embodiment, a strong lateral electric field can be applied in the effective pixel region 51 by displaying a moving image in the refresh driving. Accordingly, refresh driving time can be shortened.

Furthermore, in the present embodiment, the frequency of the refresh display can be reduced by performing the refresh display every other image display unit or performing the refresh display in two fields in a distributed manner. This makes it possible to make the refresh display inconspicuous.

### Eighth Embodiment

An eighth embodiment of the present disclosure will be described. Here, points different from the above-described seventh embodiment will be mainly described, and detailed description of similar points is omitted.

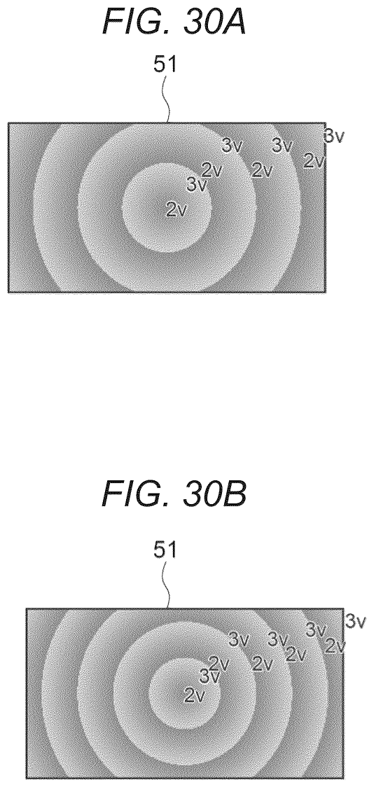

FIG. 30A is a plan view illustrating a pattern example of a moving image according to the eighth embodiment. FIG. 30A illustrates a moving image of a radiation pattern displayed in the refresh driving. In the seventh embodiment described above, the lateral electric field is created by voltage gradation of 2 V to 5 V in the effective pixel region 51.

In the present embodiment, on the other hand, as illustrated in FIG. 30A, the lateral electric field is created by a voltage gradation of 2 V to 3 V in the effective pixel region 51. That is, in the present embodiment, the moving image displayed in the refresh driving is formed into a low-gradation pattern. Therefore, the moving image illustrated in FIG. 30A is close to an image in which black is inserted, and an effect of contrast reduction is small. Furthermore, this moving image has few disadvantages in image quality although there is an effect of brightness reduction.

Note that, for example, in a case where the lateral electric field is set by a voltage gradation of 4 V to 5 V in the effective pixel region 51, the moving image is close to an image in which white is inserted, and the effect of contrast reduction increases. In addition, although brightness of this moving image increases, the display becomes whitish as a whole, and the disadvantages in image quality increase.

FIG. 30B is a plan view illustrating a pattern example of a moving image according to a modification of the eighth embodiment. In the moving image according to the present modification, as with the moving image illustrated in FIG. 30A, the lateral electric field is created by the voltage gradation of 2 V to 3 V in the effective pixel region 51. Furthermore, in the moving image according to the present modification, width of the voltage gradation is smaller than that in the moving image illustrated in FIG. 30A. That is, in the moving image according to the present modification, the number of pixels constituting the voltage gradation is smaller than that in the moving image illustrated in FIG. 30A.

Therefore, according to the present modification, the strength of the lateral electric field can be further increased. Therefore, the movement of the impurity ions 60 from the effective pixel region 51 to the non-effective region 52 can be further promoted.

### Ninth Embodiment

A ninth embodiment of the present disclosure will be described. Here, points different from the above-described seventh and eighth embodiments will be mainly described, and detailed description of similar points is omitted.

In the seventh and eighth embodiments described above, the number of types of moving images displayed in the refresh driving is one. On the other hand, in the present embodiment, two types of moving images having different display patterns are displayed in the refresh driving. Here, first, display patterns that cannot be employed in the present embodiment will be described.

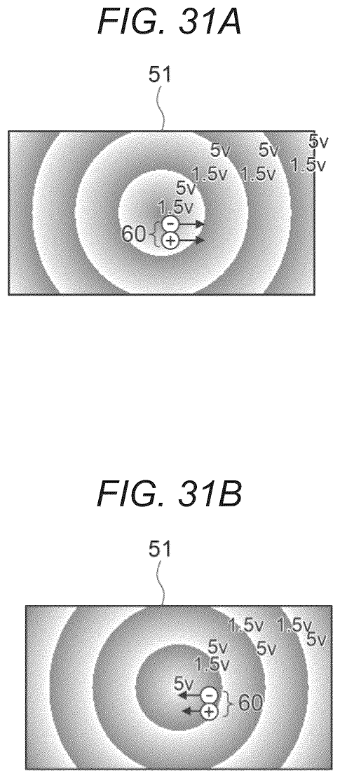

FIGS. 31A and 31B are diagrams illustrating the display patterns that cannot be employed in the ninth embodiment. In a moving image illustrated in FIG. 31A, a voltage gradation of 1.5 V to 5 V is radially created in the effective pixel region 51. On the other hand, a moving image illustrated in FIG. 31B has a pattern obtained by inverting the display pattern illustrated in FIG. 31A. Therefore, if the moving image illustrated in FIG. 31A is displayed and then the moving image illustrated in FIG. 31B is displayed at the time of the refresh driving, impurity ions 60 that have once moved from the effective pixel region 51 toward the non-effective region 52 return into the non-effective region 52, so that the impurity ions 60 cannot be diffused. Therefore, an image sticking phenomenon of the liquid crystal 440 occurs. Therefore, the employment patterns displayed in FIGS. 31A and 31B cannot be employed.

Next, display patterns employed in the present embodiment will be described.

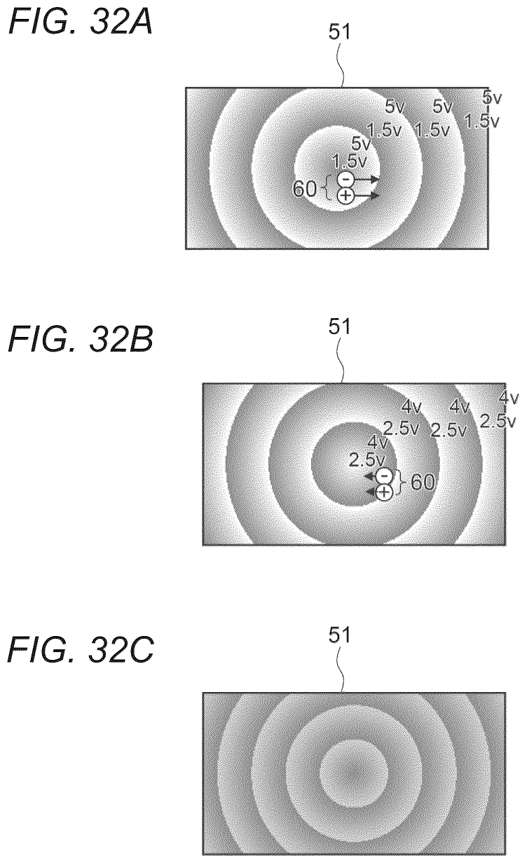

FIGS. 32A and 32B are diagrams illustrating examples of the display patterns employed in the ninth embodiment. In addition, FIG. 32C is a moving image generated by alternately displaying a first moving image pattern illustrated in FIG. 32A and a second moving image pattern illustrated in FIG. 32B.

In the first moving image pattern illustrated in FIG. 32A, a voltage gradation of 1.5 V to 5 V is radially created in the effective pixel region 51. On the other hand, the second moving image pattern illustrated in FIG. 32B has an inverted pattern with a weaker lateral electric field than in the display pattern illustrated in FIG. 32A. That is, a voltage range (2.5 V to 4 V) of a voltage gradation of the second moving image pattern illustrated in FIG. 32B is narrower than the voltage range (1.5 V to 5 V) of the voltage gradation of the first moving image pattern illustrated in FIG. 32A. Therefore, if the first moving image pattern illustrated in FIG. 32A is displayed and then the second moving image pattern illustrated in FIG. 32B is displayed at the time of refresh driving, impurity ions 60 traveling from the effective pixel region 51 to the non-effective region 52 are more dominant than impurity ions 60 returning to the effective pixel region 51. Therefore, the impurity ions 60 can be diffused. Consequently, the image sticking of the liquid crystal panel 440 hardly occurs, and the deterioration of the display characteristics can be suppressed.

In addition, by alternately displaying the moving image illustrated in FIG. 32A and the moving image illustrated in FIG. 32B and temporally canceling the moving image pattern displayed in the refresh driving, as illustrated in FIG. 32C, a moving image pattern that is visually inconspicuous to humans can be displayed.

### Tenth Embodiment

A tenth embodiment of the present disclosure will be described hereinafter with reference to the drawings.

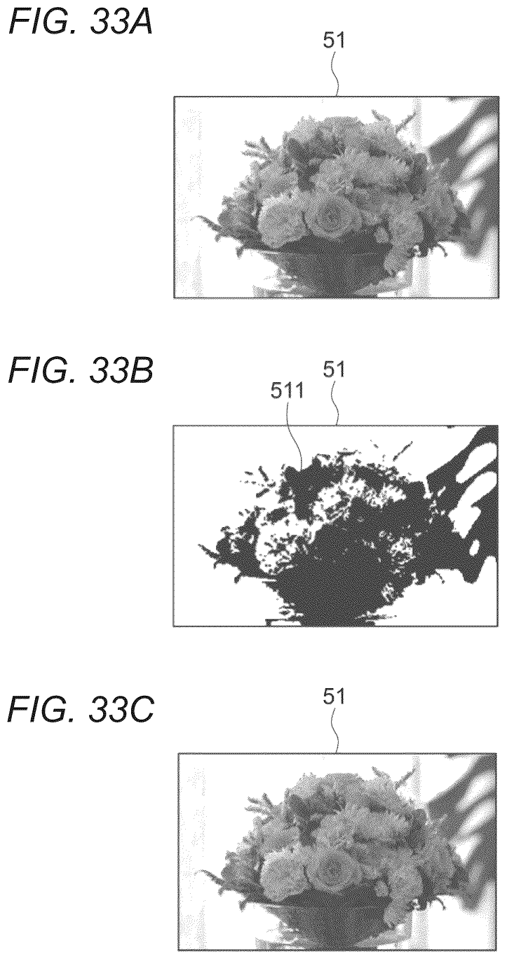

FIG. 33A is a diagram illustrating an example of an input image input to a liquid crystal panel 40h according to the tenth embodiment. Specifically, FIG. 33A is an example of an image displayed in the effective pixel region 51 of the liquid crystal panel 40h on the basis of the panel video signal.

In the present embodiment, at the time of the refresh driving, the signal processing circuit 20 first analyzes the input image illustrated in FIG. 33A, and extracts adjacent pixel regions in which pixels 50 having the same grayscale value and adjacent to each other are arranged in the effective pixel region 51.

FIG. 33B is a diagram illustrating the adjacent pixel regions extracted from the image illustrated in FIG. 33A. After extracting the adjacent pixel regions, the signal processing circuit 20 subsequently performs image processing of generating a lateral electric field in the adjacent pixel regions. Here, an example of the image processing by the signal processing circuit 20 will be described.

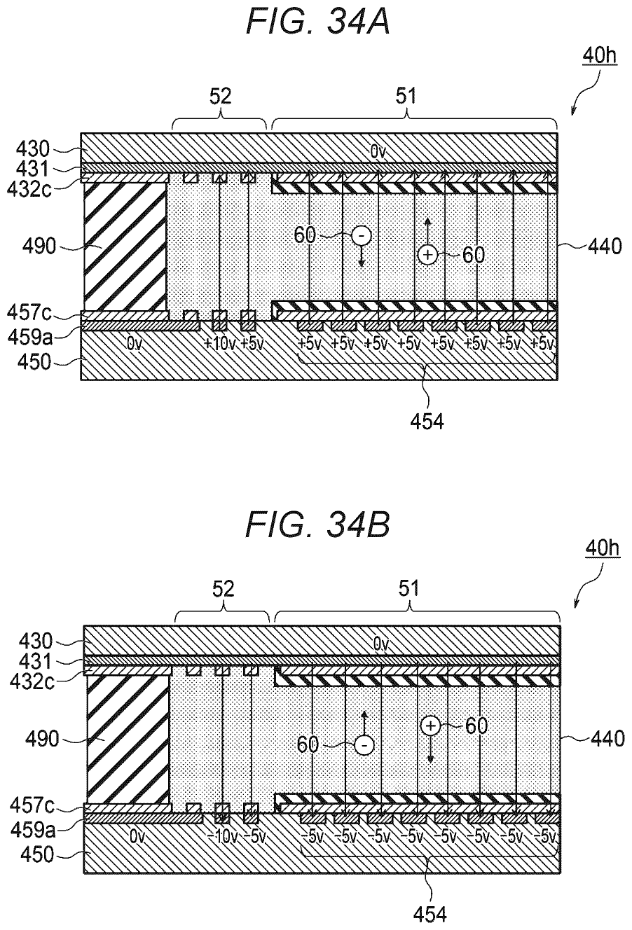

FIG. 34A is a cross-sectional view illustrating a voltage application state of an adjacent pixel region at a time when an input image of positive application is displayed. FIG. 34B is a cross-sectional view illustrating a voltage application state of the adjacent pixel region at a time when an input image of negative application is displayed.

In an adjacent pixel region 511 of the liquid crystal panel 40h illustrated in FIGS. 34A and 34B, voltage differences between the pixel electrodes 454 and the counter electrode 431 are the same. Therefore, the impurity ions 60 present in the adjacent pixel region 511 do not move in the lateral direction, that is, toward the non-effective region 52.

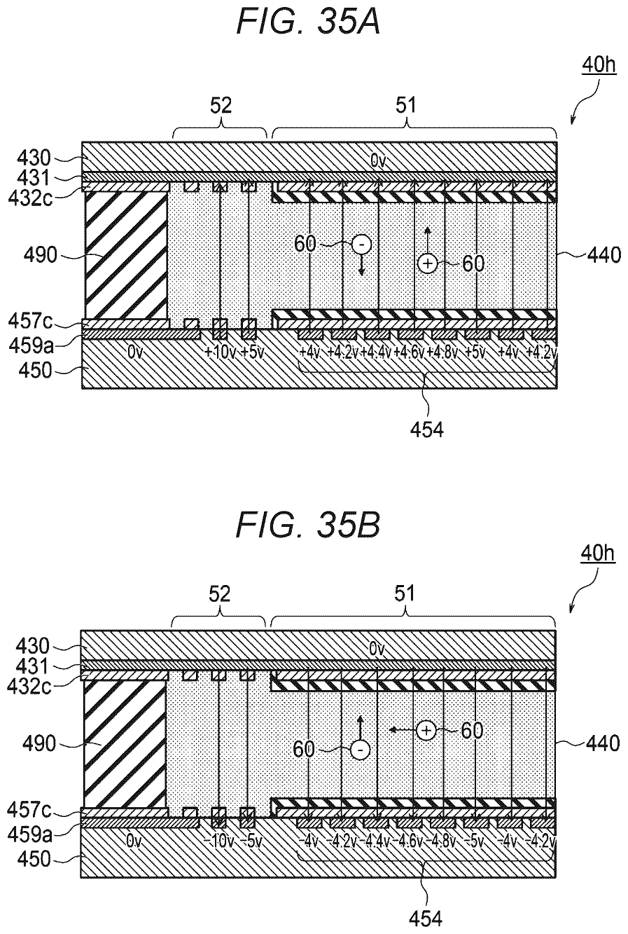

FIG. 35A is a cross-sectional view illustrating a voltage application state of an adjacent pixel region at a time when an output image of positive application is displayed. In addition, FIG. 35B is a cross-sectional view illustrating a voltage application state of the adjacent pixel region at a time when an output image of negative application is displayed. The output image is an image displayed on the liquid crystal panel 40h after the image processing by the signal processing circuit 20.

In the adjacent pixel region illustrated in FIGS. 35A and 35B, voltage differences between the pixel electrodes 454 and the counter electrode 431 are different between adjacent pixels. Therefore, the impurity ions 60 present in the adjacent pixel region tend to move in the lateral direction, that is, toward the non-effective region 52.

The signal processing circuit 20 temporally changes the potential of each pixel electrode 454 in each display of positive application or negative application. At this time, the signal processing circuit 20 changes the gradation, that is, the voltage differences between the pixel electrodes 454 and the counter electrode 431 within a minute range of, for example, 0.2 V to 1.0 V between adjacent pixels. As a result, an output image illustrated in FIG. 33C is displayed in the effective pixel region 51. At this time, when the signal processing circuit 20 scrolls the gradation of the output image, it looks like a raster to humans with time integration. Therefore, it is possible to suppress image sticking of the liquid crystal 440 due to the impurity ions 60 while minimizing a gradation difference between an input image and an output image.

### Eleventh Embodiment

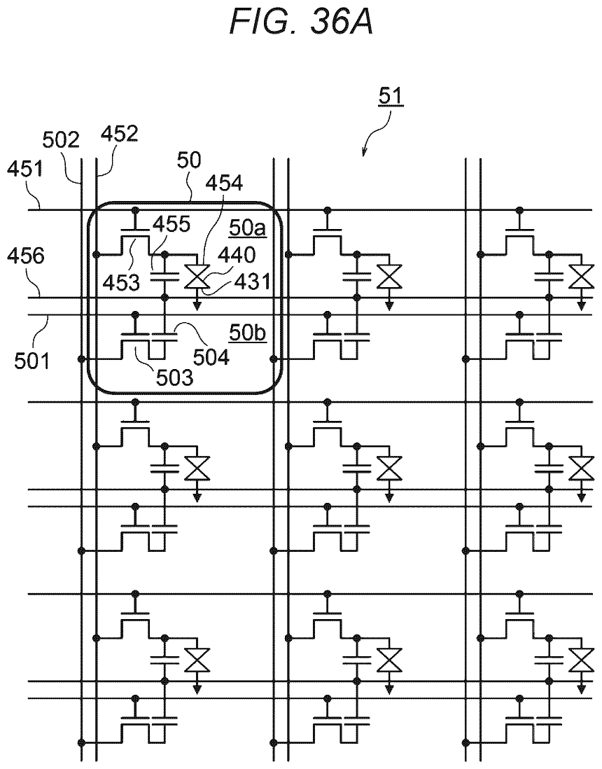

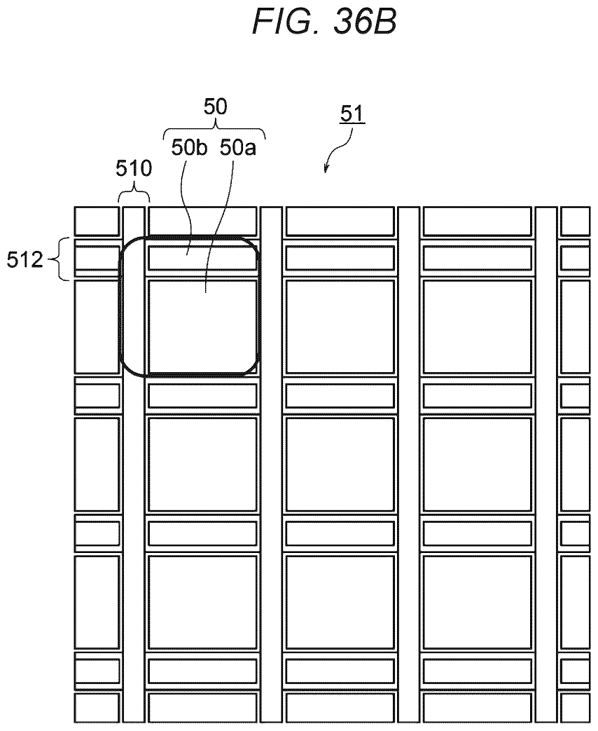

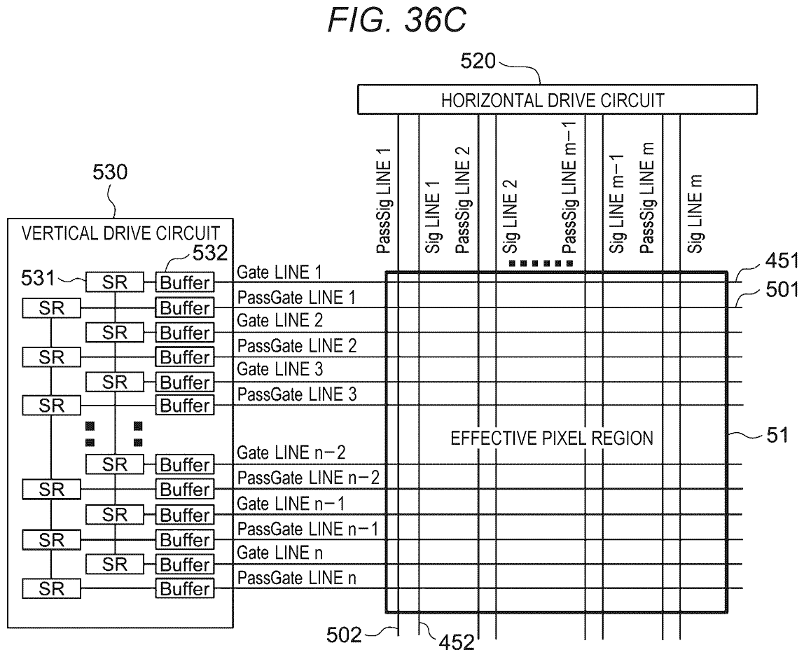

FIG. 36A is an equivalent circuit diagram of pixels according to an eleventh embodiment. As illustrated in FIG. 36A, each pixel 50 according to the present embodiment includes a first pixel portion 50a and a second pixel portion 50b. The first pixel portion 50a includes the pixel transistor 453 (first pixel transistor), the pixel electrode 454, the liquid crystal 440, the counter electrode 431, and the capacitive element 455. Circuit configuration of the first pixel portion 50a is similar to that in the first embodiment illustrated in FIG. 6, and description thereof is omitted.

The second pixel portion 50b includes a pixel transistor 503 (second pixel transistor) and a capacitive element 504. The pixel transistor 503 includes, for example, an n-channel MOS transistor. A pass gate line 501 is connected to a gate of the pixel transistor 503. In addition, a pass signal line 502 is connected to a drain of the pixel transistor 503. An end of the capacitive element 504 is connected to a source of the pixel transistor 503. Another end of the capacitive element 504 is commonly connected to the capacitive element 455 by a common wiring 456.

FIG. 36B is a layout diagram of the effective pixel region 51 including the pixel 50 illustrated in FIG. 36A. In FIG. 36B, longitudinal wiring regions 510 and lateral wiring regions 512 are arranged in a lattice pattern. The signal lines 452 and the pass signal lines 502 are arranged in the longitudinal wiring regions 510. The gate lines 451, the common wirings 456, and the pass gate lines 501 are arranged in the lateral wiring regions 512.

The first pixel portions 50a are arranged in light transmission regions surrounded by the longitudinal wiring regions 510 and the lateral wiring regions 512. On the other hand, the second pixel portions 50b are arranged in non-light transmitting regions located on the lateral wiring regions 512.

FIG. 36C is a diagram illustrating drive configuration of the pixel 50 arranged in the effective pixel region 51 illustrated in FIG. 36B. The pixel 50 is driven by the vertical drive circuit 530 and the horizontal drive circuit 520. The vertical drive circuit 530 controls a switching operation of the pixel transistor 453 through the pass gate line 501, and controls a switching operation of the pixel transistor 503 through the pass gate line 501. Here, circuit configuration of the vertical drive circuit 530 will be described.

The vertical drive circuit 530 includes a shift register (SR) 531 and a buffer 532 connected to the shift register 531. The shift register 531 and the buffer 532 are provided for each pass gate line 501 and for each pass gate line 501. That is, the number of shift registers 531 and buffers 532 is the sum of the number of pass gate lines 501 and the number of pass gate lines 501.

The shift register 531 generates control signals input to the gate of the pixel transistor 453 and the gate of the pixel transistor 503, respectively. The buffer 532 adjusts (amplifies) voltages of the control signals generated by the shift register 531 to voltages at which the pixel transistor 453 and the pixel transistor 503 can perform the switching operation.

The horizontal drive circuit 520 writes the potential of the pixel electrode 454 in the first pixel portion 50a through the signal line 452, and writes the potential of the pixel electrode in the second pixel portion 50b through the pass signal line 502. At this time, the horizontal drive circuit 520 generates a lateral electric field in the effective pixel region 51 by writing a potential similar to that in each of the above-described seventh to tenth embodiments in the second pixel portion 50b. Note that update rates of the potentials written in the first pixel portion 50a and the second pixel portion 50b are not necessarily the same. That is, a timing at which the horizontal drive circuit 520 updates the potential to be written in the first pixel portion 50a may be different from a timing at which the potential to be written in the second pixel portion 50b is updated.

According to the present embodiment described above, the second pixel portion 50b is provided as a refresh driving-only pixel that guides the impurity ions 60 to the non-effective region 52. Consequently, the image sticking of the liquid crystal 440 in the effective pixel region 51 hardly occurs, and the deterioration of the display characteristics can be suppressed.

Furthermore, in the present embodiment, the pixel transistor 503 of the second pixel portion 50b is controlled by the pass gate line 501 different from the gate line 451. Therefore, the driving of the pixel transistor 503 can be controlled independently of the pixel transistor 453.

### Twelfth Embodiment

A twelfth embodiment of the present disclosure will be described. Here, points different from the above-described eleventh embodiment will be mainly described, and detailed description of similar points is omitted.

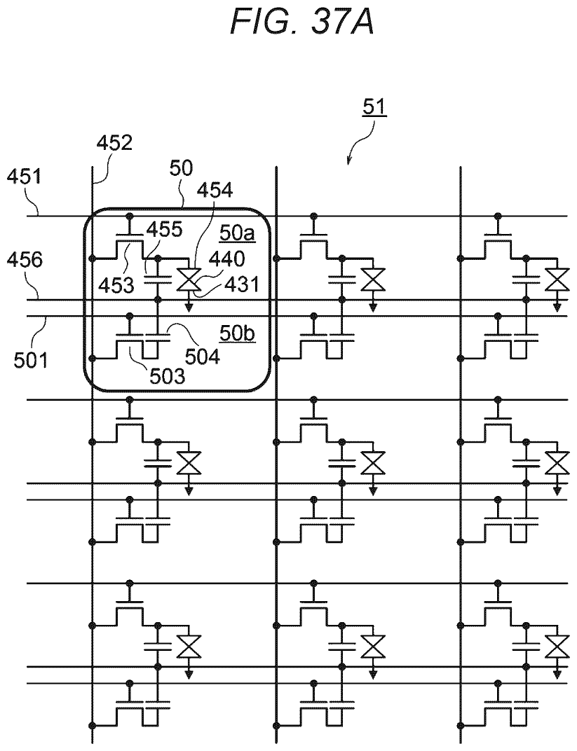

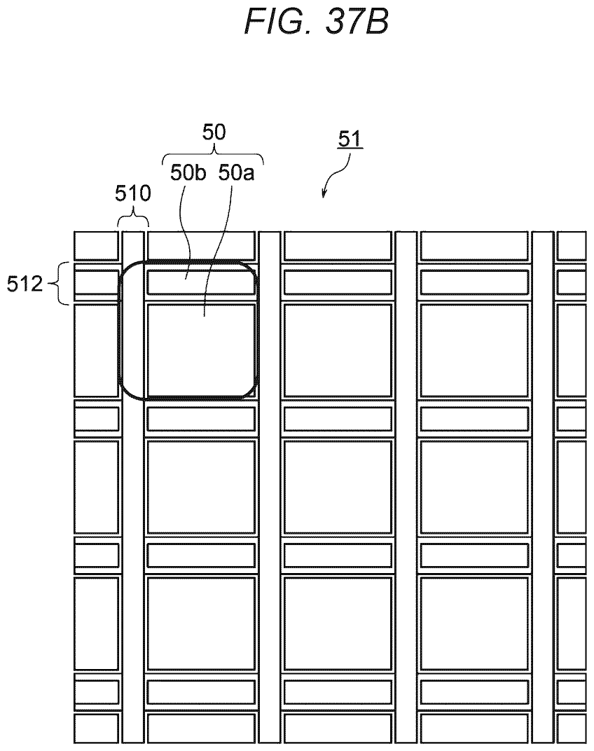

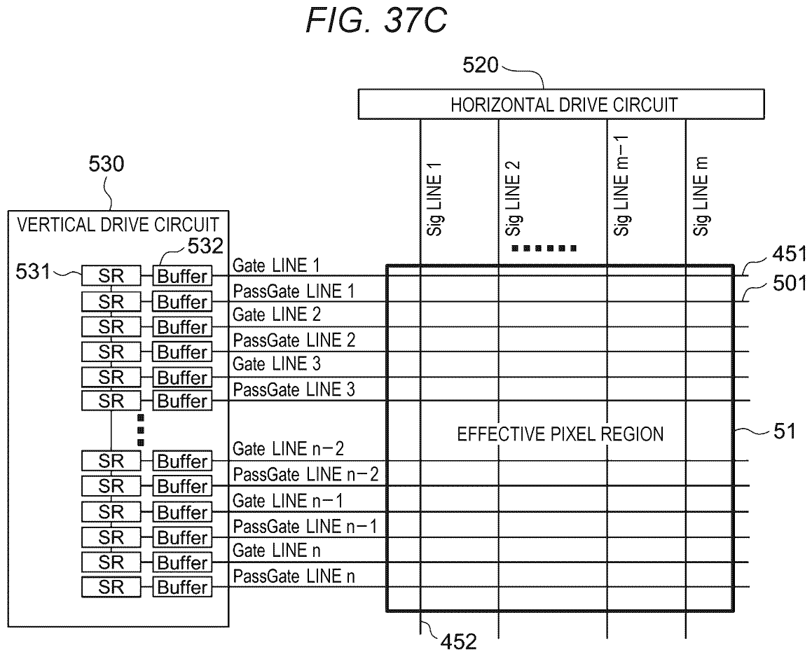

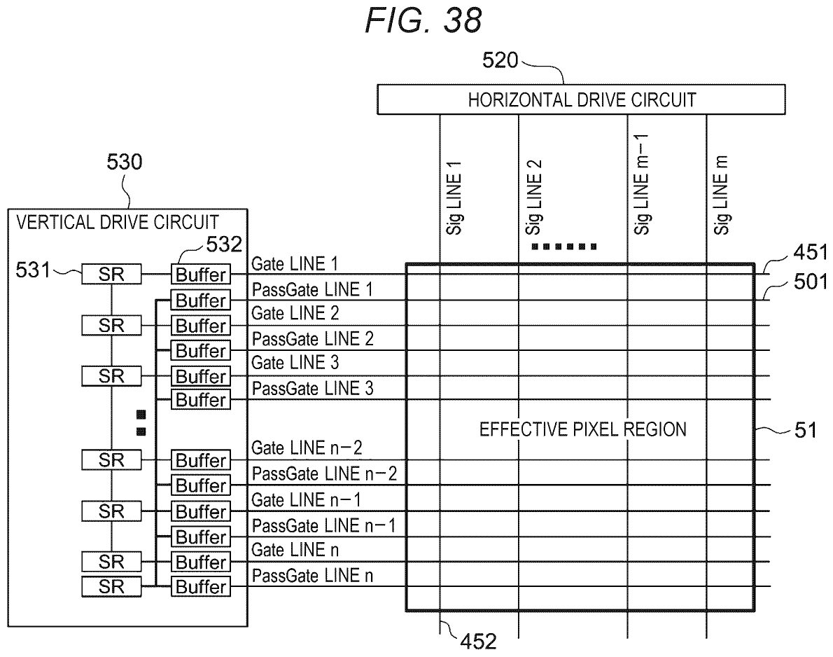

FIG. 37A is an equivalent circuit diagram of pixels according to a twelfth embodiment. As illustrated in FIG. 37A, each pixel 50 according to the present embodiment also includes the first pixel portion 50a and the second pixel portion 50b as in the eleventh embodiment. On the other hand, in the present embodiment, the drain of the pixel transistor 503 is connected to the signal line 452 in common with the drain of the pixel transistor 453.

FIG. 37B is a layout diagram of the effective pixel region 51 including the pixel 50 illustrated in FIG. 37A. As illustrated in FIG. 37B, also in the present embodiment, the longitudinal wiring regions 510 and the lateral wiring regions 512 are arranged in a lattice pattern as in the eleventh embodiment. However, in the present embodiment, only the signal lines 452 are arranged in the longitudinal wiring regions 510.

FIG. 37C is a diagram illustrating drive configuration of the pixel 50 arranged in the effective pixel region 51 illustrated in FIG. 37B. Also in the present embodiment, the vertical drive circuit 530 includes the shift register 531 and the buffer 532 connected to the shift register 531. On the other hand, the horizontal drive circuit 520 writes the potential of the pixel electrode 454 in the first pixel portion 50a through the signal line 452, and writes the potential of the pixel electrode in the second pixel portion 50b. At this time, for example, the horizontal drive circuit 520 may alternately set the potential of the pixel electrode to the first pixel portion 50a and the second pixel portion 50b. Note that, in the present embodiment, there is no restriction on the potential of the second pixel portion 50b.

FIG. 38 is a diagram illustrating drive configuration of a pixel 50 according to a first modification of the twelfth embodiment. In the present modification, the buffers 532 connected to the pass gate lines 501 are individually connected to the shift registers 531. On the other hand, the buffers 532 connected to the pass gate lines 501 are commonly connected to one shift register 531.

In the present modification, first, the horizontal drive circuit 520 sequentially writes pixel potentials in the first pixel portions 50a through the signal lines 452. Subsequently, the vertical drive circuit 530 turns on all the pixel transistors 503 in the second pixel portions 50b all at once by control signals output to the pass gate lines 501. Lastly, the horizontal drive circuit 520 simultaneously writes the pixel potentials to all the second pixel portions 50b through the signal lines 452. At this time, the pixel potentials of the second pixel portions 50b are all the same.

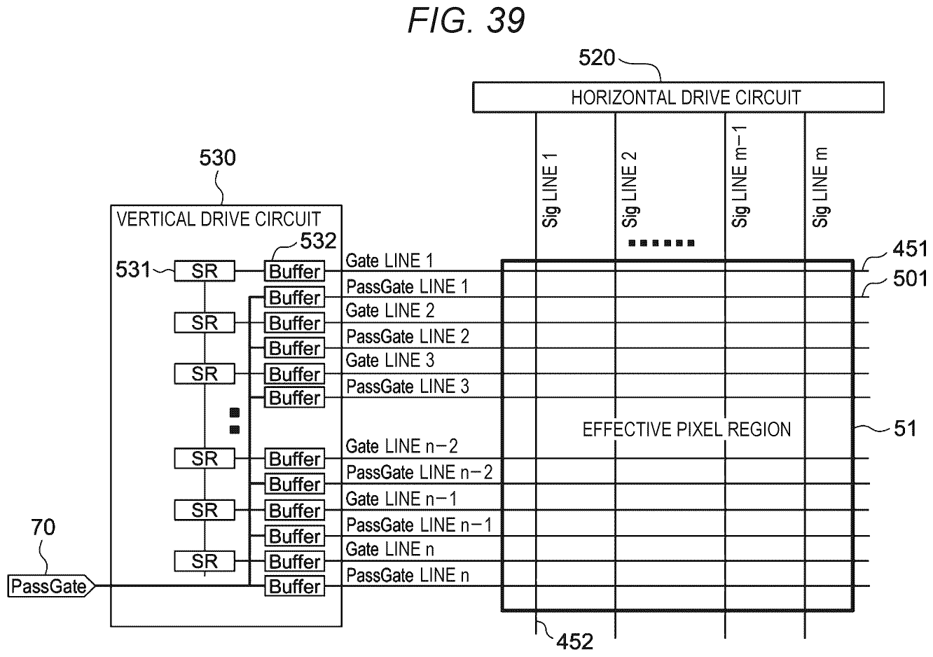

FIG. 39 is a diagram illustrating drive configuration of a pixel 50 according to a second modification of the twelfth embodiment. Also in the present modification, the buffers 532 connected to the pass gate lines 501 are individually connected to the shift registers 531. On the other hand, the buffers 532 connected to the pass gate lines 501 are commonly connected to a signal generation circuit 70. That is, in the present modification, input systems of gate signals are separated between the pixel transistors 453 and the pixel transistors 503.

In the present modification, first, the horizontal drive circuit 520 sequentially writes pixel potentials in the first pixel portions 50a through the signal lines 452. Subsequently, the signal generation circuit 70 turns on all the pixel transistors 503 in the second pixel portions 50b all at once by control signals output to the pass gate lines 501 via the buffers 532. Lastly, the horizontal drive circuit 520 simultaneously writes the pixel potentials to all the second pixel portions 50b through the signal lines 452. At this time, also in the present modification, the pixel potentials of the second pixel portions 50b are all the same.

According to the present embodiment and the present modifications described above, the second pixel portion 50b is provided as a dedicated pixel that guides the impurity ions 60 to the non-effective region 52. Consequently, the image sticking of the liquid crystal panel 440 in the effective pixel region 51 hardly occurs, and the deterioration of the display characteristics can be suppressed.

Furthermore, in the present embodiment, the signal lines 452 are shared between the first pixel portions 50a and the second pixel portions 50b. Therefore, the number of wirings is reduced as compared with the eleventh embodiment. Therefore, an aperture of the pixel 50 can be increased to enlarge the light transmission region.

### Thirteenth Embodiment

A thirteenth embodiment of the present disclosure will be described. Here, points different from the above-described eleventh embodiment will be mainly described, and detailed description of similar points is omitted.

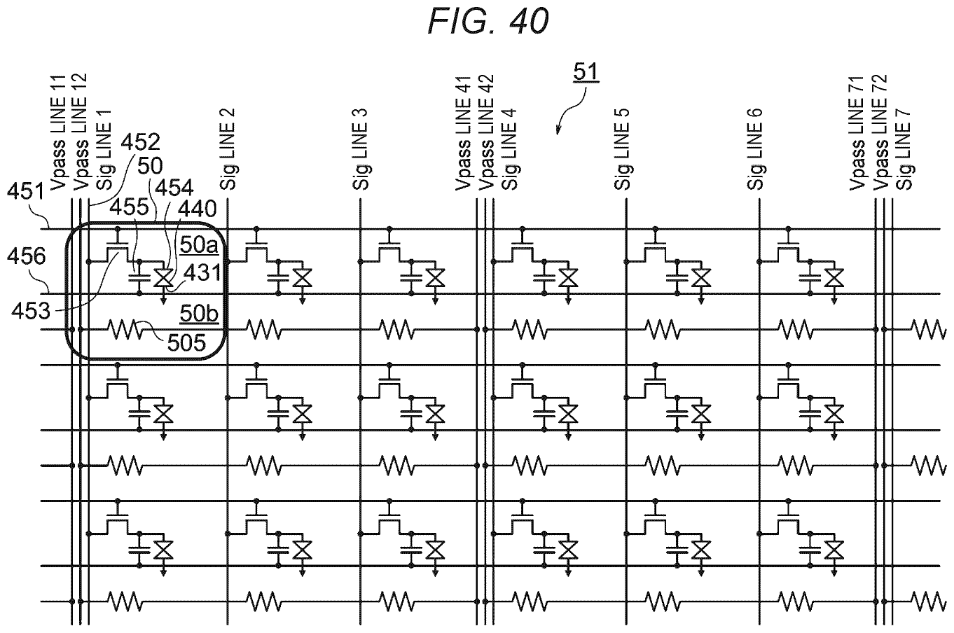

FIG. 40 is an equivalent circuit diagram of pixels according to the thirteenth embodiment. As illustrated in FIG. 40, each pixel 50 according to the present embodiment also includes the first pixel portion 50a and the second pixel portion 50b as in the eleventh embodiment. However, a resistance element 505 is provided in the second pixel portion 50b in the present embodiment. In addition, resistance elements 505 provided in a plurality of adjacent pixels 50 are connected in series with each other. For example, in FIG. 40, three resistance elements 505 are connected in series with each other.

In addition, in the present embodiment, two voltage pass (Vpass) lines having different potentials are provided for each signal line 452. In FIG. 40, potentials of voltage pass lines 11, 41, and 71 are higher than potentials of voltage pass lines 12, 42, and 72, respectively. Two ends of the group of resistance elements 505 connected in series with each other are connected to a high-potential voltage pass line and a low-potential voltage pass line, respectively. In FIG. 40, three resistance elements 505 are connected between the low-potential voltage pass line 12 and the high-potential voltage pass line 41. In this case, when voltages are applied to the voltage pass line 12 and the voltage pass line 41, a potential of each of the second pixel portions 50b is determined by resistance division. As a result, a lateral electric field is generated. Due to the generated lateral electric field, the impurity ions 60 present in the effective pixel region 51 are urged to move toward the non-effective region 52.

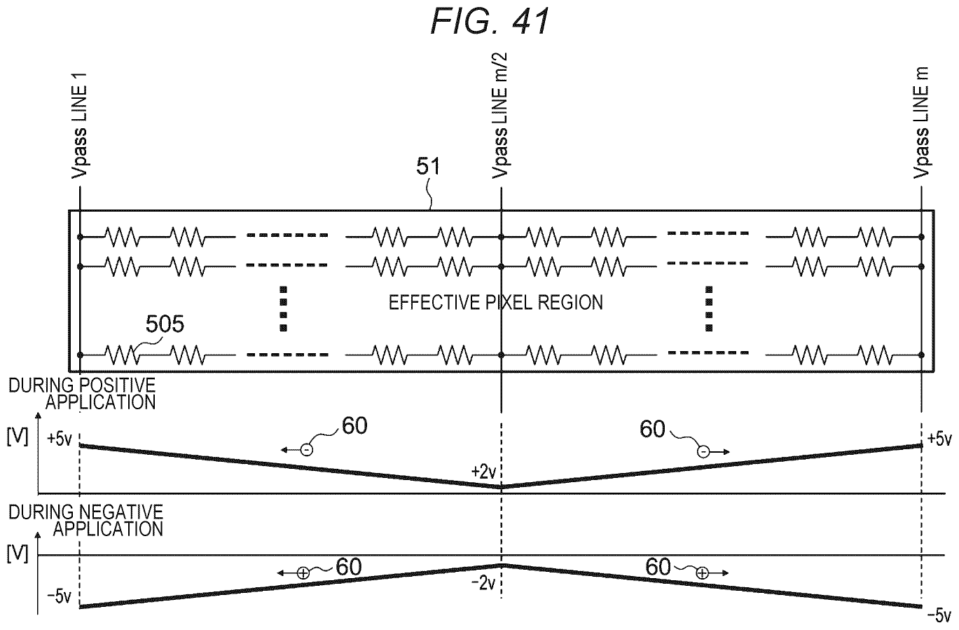

FIG. 41 is a diagram illustrating an example of a lateral electric field generated in the effective pixel region 51 in a case where the resistance division is not performed. In FIG. 41, voltage pass lines are arranged at both ends and the center of the effective pixel region 51.

In a case where the pixels 50 are driven by positive application, the voltage pass line (Vpass line m/2) arranged at the center of the effective pixel region 51 becomes a low-potential voltage pass line to which 2 V is applied, and the voltage pass lines (Vpass line l and Vpass line m) arranged at both ends of the effective pixel region 51 become high-potential voltage pass lines to which 5 V is applied. As a result, a lateral electric field having a voltage range of 2 V to 5 V is generated from the center to both ends of the effective pixel region 51. As a result, negative impurity ions 60 move through the effective pixel region 51 in the lateral direction.

In a case where the pixels 50 are driven by negative application, on the other hand, the voltage pass line arranged at the center of the effective pixel region 51 becomes a high-potential voltage pass line to which −2 V is applied, and the voltage pass lines (Vpass line l and Vpass line m) arranged at both ends of the effective pixel region 51 become low-potential voltage pass lines to which −5 V is applied. As a result, a lateral electric field having a voltage range of −5 V to −2 V is generated from the center to both ends of the effective pixel region 51. As a result, positive impurity ions 60 move through the effective pixel region 51 in the lateral direction.

In the example illustrated in FIG. 41, the potentials of the voltage pass lines may be two types of voltages in the positive application or the negative application. However, since a potential difference between adjacent pixels in the lateral direction is small, the lateral electric field might be weak. In this case, the movement of the impurity ions 60 might be insufficient. Therefore, in the present embodiment, a lateral electric field is generated in the effective pixel region 51 by resistance division.

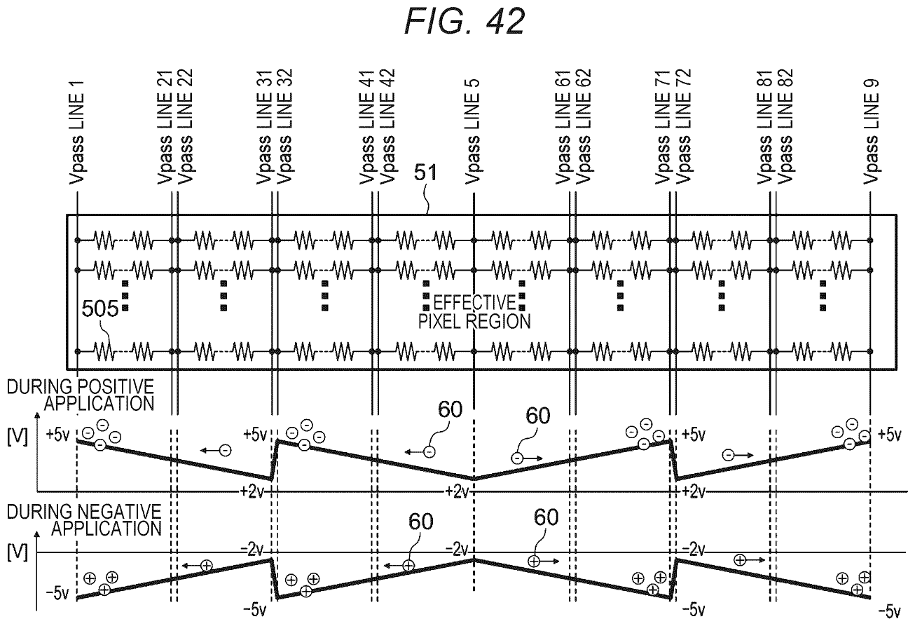

FIG. 42 is a diagram illustrating an example of a lateral electric field generated in the effective pixel region 51 in a case where the resistance division is performed. In FIG. 42, the plurality of resistance elements 505 is divided by voltage pass lines in such a way as to generate a lateral electric field having two types of voltage changes in the effective pixel region 51.

In a case where the pixels 50 are driven by positive application, the resistance elements 505 are divided by voltage pass lines illustrated in FIG. 42, so that a voltage change for boosting from 2 V to 5 V and a voltage change for stepping down from 5 V to 2 V are alternately repeated from the center to both ends of the effective pixel region 51. In addition, the step-down change is achieved by dividing the series connection of the resistance elements 505 by two voltage pass lines having different potentials, for example, a Vpass line 31 and a Vpass line 32. As a result, negative impurity ions 60 move through the effective pixel region 51 in the lateral direction.

In a case where the pixels 50 are driven by negative application, the resistance elements 505 are divided by voltage pass lines illustrated in FIG. 42, so that a voltage change for stepping down from −2 V to −5 V and a voltage change for boosting from −5 V to −2 V are alternately repeated from the center to both ends of the effective pixel region 51. In addition, the boost change is achieved by dividing the series connection of the resistance elements 505 by two voltage pass lines having different potentials, for example, the Vpass line 31 and the Vpass line 32. As a result, positive impurity ions 60 move through the effective pixel region 51 in the lateral direction.

In the example illustrated in FIG. 42, a potential difference between pixels adjacent in the lateral direction is larger than that in the example illustrated in FIG. 41. Therefore, the lateral electric field becomes strong. As a result, the movement of the impurity ions 60 is promoted, so that the image sticking phenomenon of the liquid crystal 440 is less likely to occur.

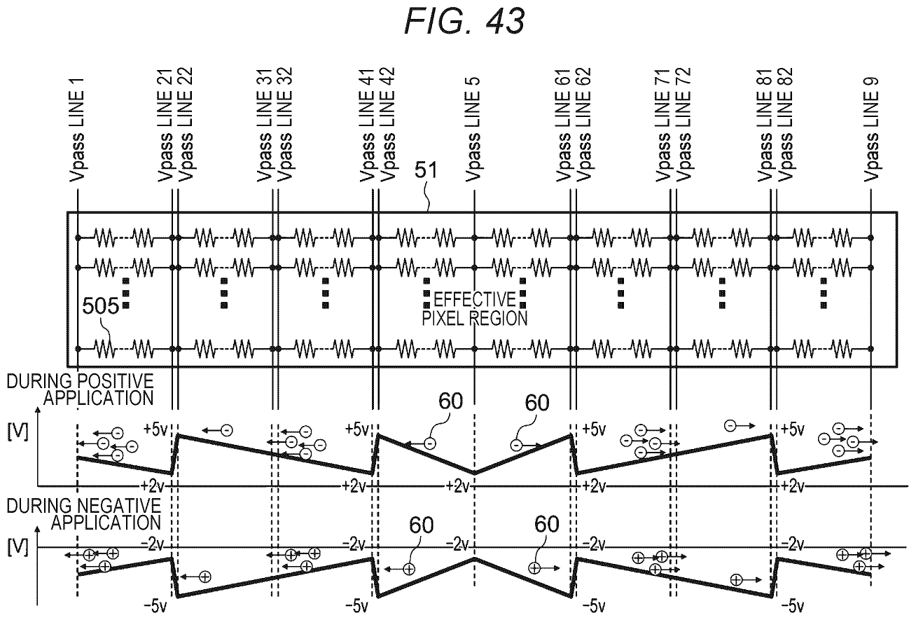

FIG. 43 is a diagram illustrating a modification of the lateral electric field generated in the effective pixel region 51 in a case where the resistance division is performed. In the example illustrated in FIG. 43, the number of divisions of the connection of the resistance elements 505 by voltage pass lines is larger than that in the example illustrated in FIG. 42. Consequently, a stronger lateral electric field is generated in the effective pixel region 51. As a result, the movement of the impurity ions 60 is further promoted, so that the image sticking phenomenon of the liquid crystal 440 is even less likely to occur.

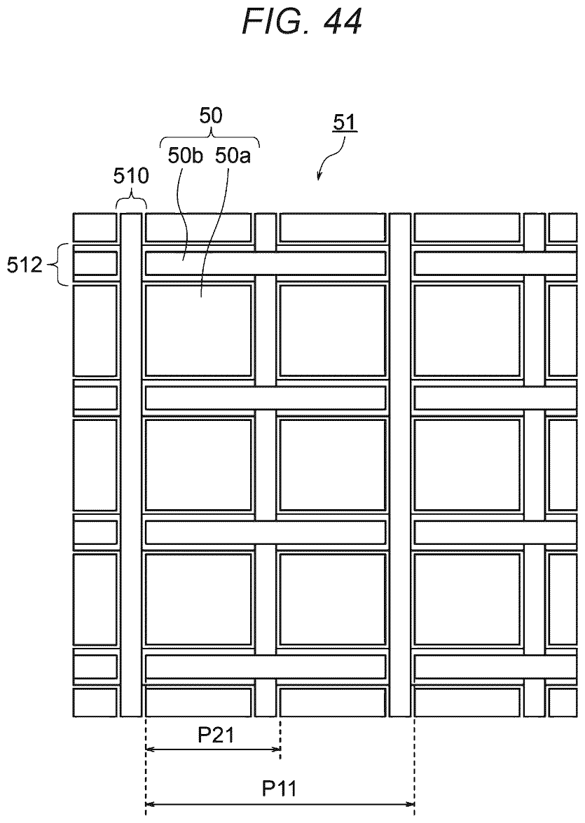

FIG. 44 is a layout diagram of an effective pixel region 51 including the pixels 50 according to the thirteenth embodiment. As illustrated in FIG. 44, in the effective pixel region 51, the longitudinal wiring regions 510 and the lateral wiring regions 512 are arranged in a lattice pattern. In the longitudinal wiring regions 510, the voltage pass lines illustrated in FIGS. 40 to 43 are arranged together with the signal lines 452. In the lateral wiring regions 512, on the other hand, the gate lines 451, the common wirings 456, and the pass gate lines 501 are arranged.

The first pixel portions 50a are arranged in light transmission regions surrounded by the longitudinal wiring regions 510 and the lateral wiring regions 512. On the other hand, the second pixel portions 50b are arranged in non-light transmitting regions located on the lateral wiring regions 512. In FIG. 44, a lateral pitch P11 of the second pixel portions 50b is wider than, that is, about twice as wide as, a lateral pitch P21 of the first pixel portions 50a. However, the layout of the second pixel portions 50b is not limited to the example illustrated in FIG. 44.

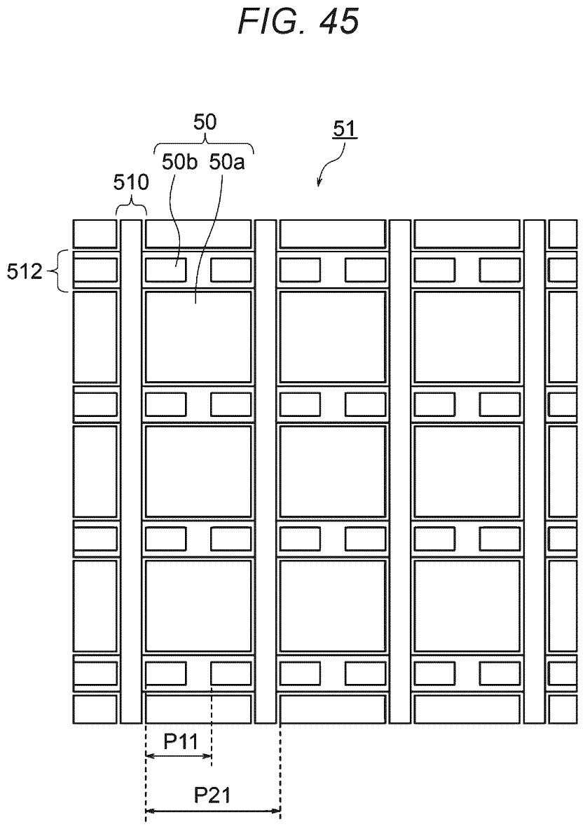

FIG. 45 is a layout diagram of an effective pixel region 51 according to a first modification of the thirteenth embodiment. Also in the present modification, the second pixel portions 50b are arranged in the non-light transmitting regions located on the lateral wiring regions 512. In the present modification, however, as illustrated in FIG. 45, the lateral pitch P11 of the second pixel portions 50b is narrower than, that is, about twice as narrow as, the lateral pitch P21 of the first pixel portions 50a.

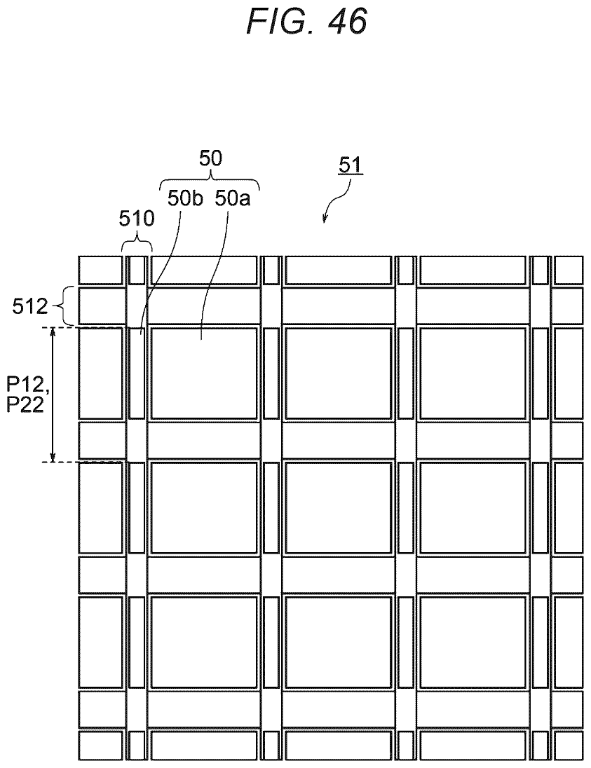

FIG. 46 is a layout diagram of an effective pixel region 51 according to a second modification of the thirteenth embodiment. In the present modification, the second pixel portions 50b are arranged in non-light transmitting regions located on the longitudinal wiring regions 510. In addition, the pitch P12 of the second pixel portions 50b in the longitudinal direction is substantially the same as a pitch P22 of the first pixel portions 50a in the longitudinal direction.

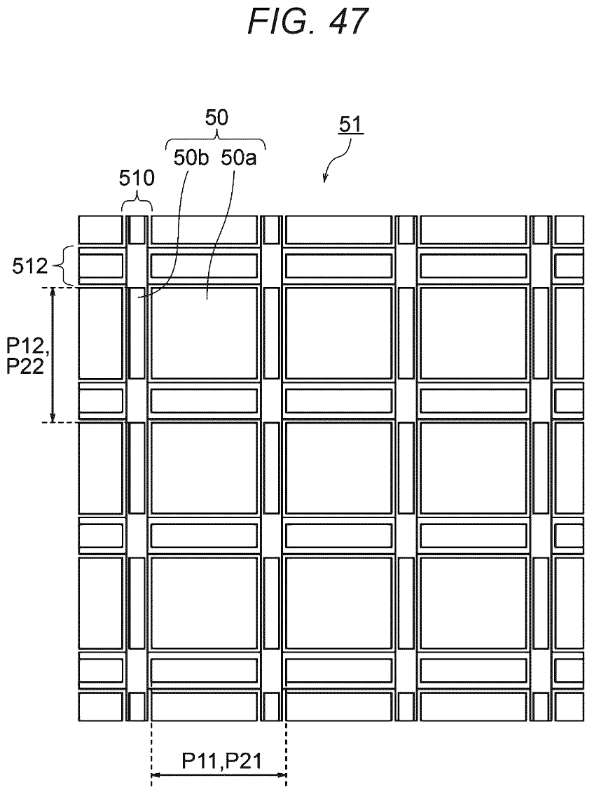

FIG. 47 is a layout diagram of an effective pixel region 51 according to a third modification of the thirteenth embodiment. In the present modification, the second pixel portions 50b are arranged in both non-light transmitting regions located on the longitudinal wiring regions 510 and non-light transmitting regions located on the lateral wiring regions 512. In addition, the pitch P11 of the second pixel portions 50b in the lateral direction is substantially the same as the pitch P21 of the first pixel portions 50a in the lateral direction. Furthermore, the pitch P12 of the second pixel portions 50b in the longitudinal direction is also substantially the same as the pitch P22 of the first pixel portions 50a in the longitudinal direction.

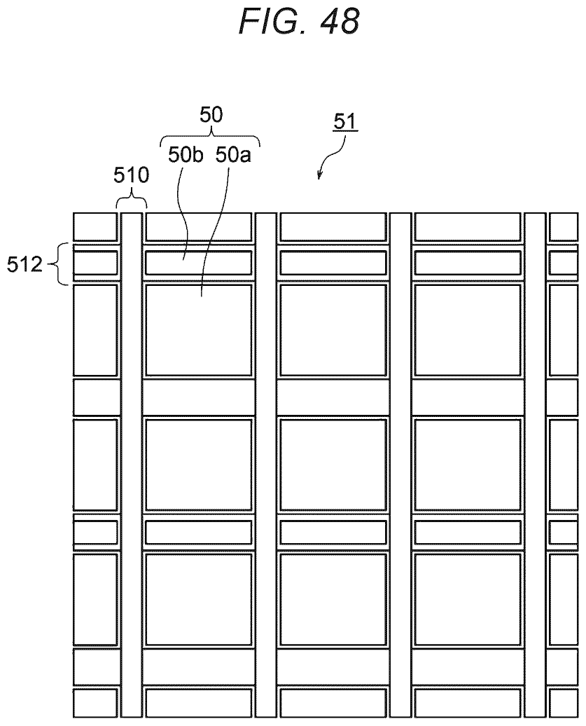

FIG. 48 is a layout diagram of an effective pixel region 51 according to a fourth modification of the thirteenth embodiment. In the present modification, the second pixel portions 50b are arranged in non-light transmitting regions located on the lateral wiring regions 512. However, as illustrated in FIG. 48, the second pixel portions 50b are arranged in every other row of the lateral wiring regions 512. Note that the second pixel portions 50b may be arranged not every other row but at intervals of a plurality of rows such as every third row.

According to the present embodiment described above, the second pixel portions 50b are provided as dedicated pixels that guide the impurity ions 60 to the non-effective region 52. Consequently, the image sticking of the liquid crystal panel 440 in the effective pixel region 51 hardly occurs, and the deterioration of the display characteristics can be suppressed.

Furthermore, in the present embodiment, the second pixel portions 50b include the resistance elements 505. Therefore, the configuration of the second pixel portions 50b can be simplified.

The liquid crystal display devices described in the first to thirteenth embodiments can be employed for various electronic apparatuses. Application examples of the liquid crystal display device will be described hereinafter.

### First Application Example

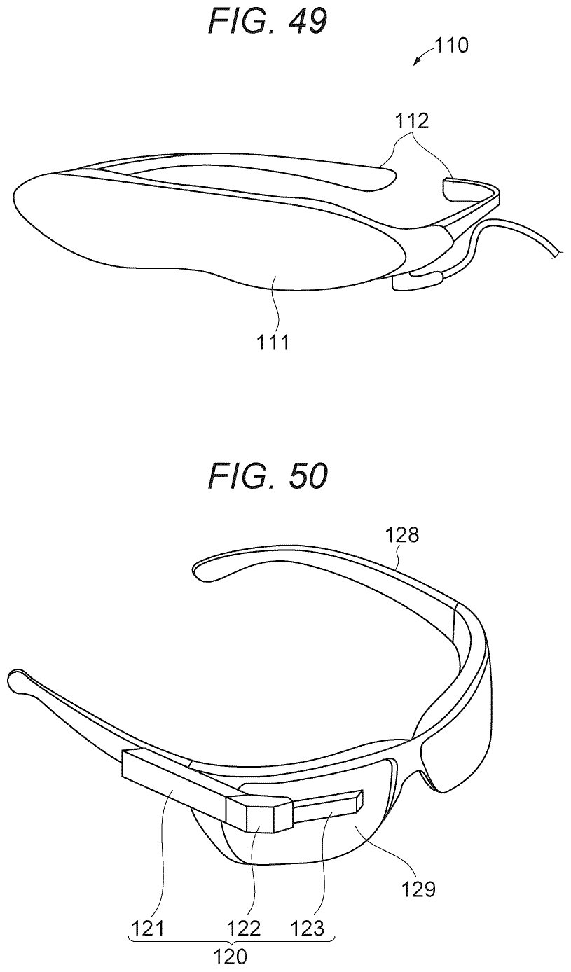

FIG. 49 is a diagram illustrating an example of external appearance of a head mounted display 110. The head mounted display 110 includes, for example, ear hooking portions 112 to be worn on the head of the user on both sides of an eyeglass-shaped display unit 111. The liquid crystal display devices according to the above embodiments and the like can be employed for the head mounted display 110.

### Second Application Example

FIG. 50 is a diagram illustrating an example of external appearance of another head mounted display 120. The head mounted display 120 is a transmissive head mounted display including a main body portion 121, an arm portion 122, and a lens barrel portion 123. The head mounted display 120 is mounted on glasses 128. The main body portion 121 includes a control board for controlling operation of the head mounted display 120, and a display unit. The display unit emits image light of a display image. The arm portion 122 connects the main body portion 121 and the lens barrel portion 123 and supports the lens barrel portion 123. The lens barrel portion 123 projects image light supplied from the main body portion 121 via the arm portion 122 toward the user's eyes via lenses 129 of the glasses 128. The liquid crystal display devices according to the above embodiments and the like can be employed for the head mounted display 120.

Note that the head mounted display 120 is a so-called light guide plate type head mounted display, but is not limited thereto, and may be, for example, a so-called birdbath type head mounted display. The birdbath type head mounted display includes, for example, a beam splitter and a partially transparent mirror. The beam splitter outputs light encoded with image information toward the mirror, and the mirror reflects the light toward the user's eyes. Both the beam splitter and the partially transparent mirror are partially transparent. Thus, light from the surrounding environment reaches the eyes of the user.

### Third Application Example

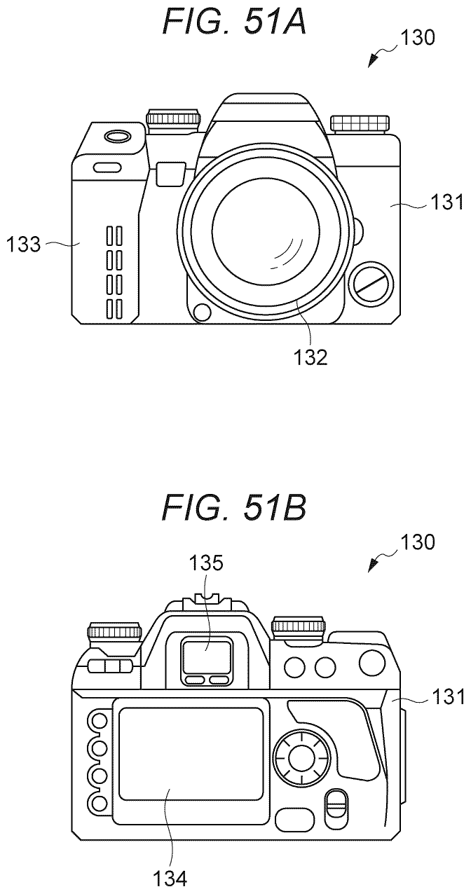

FIGS. 51A and 51B are diagrams illustrating an example of external appearance of a digital still camera 130. FIG. 51A is a front view, and FIG. 51B is a rear view. The digital still camera 130 is a lens interchangeable single-lens reflex type camera, and includes a camera main body portion (camera body) 131, an imaging lens unit 132, a grip portion 133, a monitor 134, and an electronic viewfinder 135. The imaging lens unit 132 is an interchangeable lens unit, and is provided near substantially the center of a front surface of the camera main body portion 131. The grip portion 133 is provided on a left side of the front surface of the camera main body portion 131, and a camera operator grips the grip portion 133. The monitor 134 is provided on a left side of substantially the center of the back surface of the camera main body portion 131. The electronic viewfinder 135 is provided on the upper part of the monitor 134 on the back surface of the camera main body portion 131. By looking into the electronic viewfinder 135, the camera operator can visually recognize an optical image of the subject guided from the imaging lens unit 132 and determine the composition. The liquid crystal display devices according to the above embodiments and the like can be employed for the electronic viewfinder 135.

### Fourth Application Example

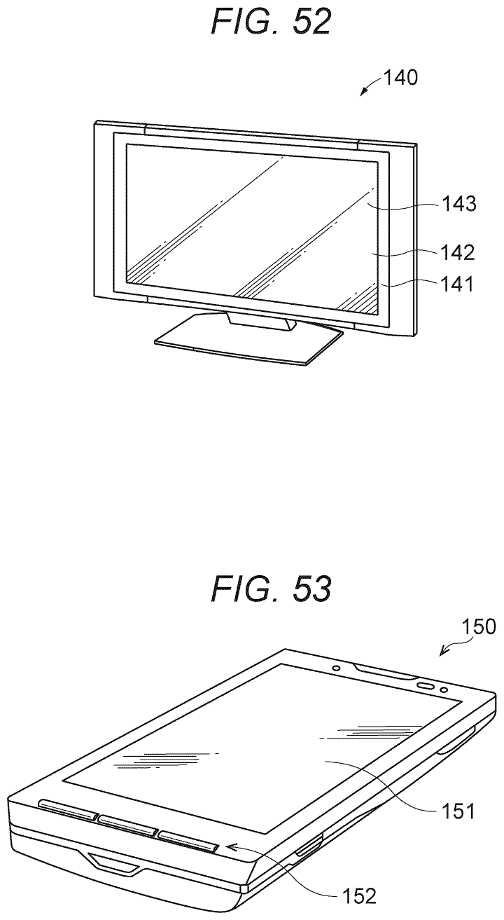

FIG. 52 is a diagram illustrating an example of external appearance of a television apparatus 140. The television apparatus 140 includes a video display screen portion 141 including a front panel 142 and a filter glass 143. The liquid crystal display devices according to the above embodiment and the like can be employed for the video display screen portion 141.

### Fifth Application Example

FIG. 53 is a diagram illustrating an example of external appearance of a smartphone 150. The smartphone 150 includes a display portion 151 that displays various types of information and an operation portion 152 including a button that receives an operation input by the user and the like. The liquid crystal display devices according to the above embodiment and the like can be employed for the display portion 151.

### Sixth Application Example

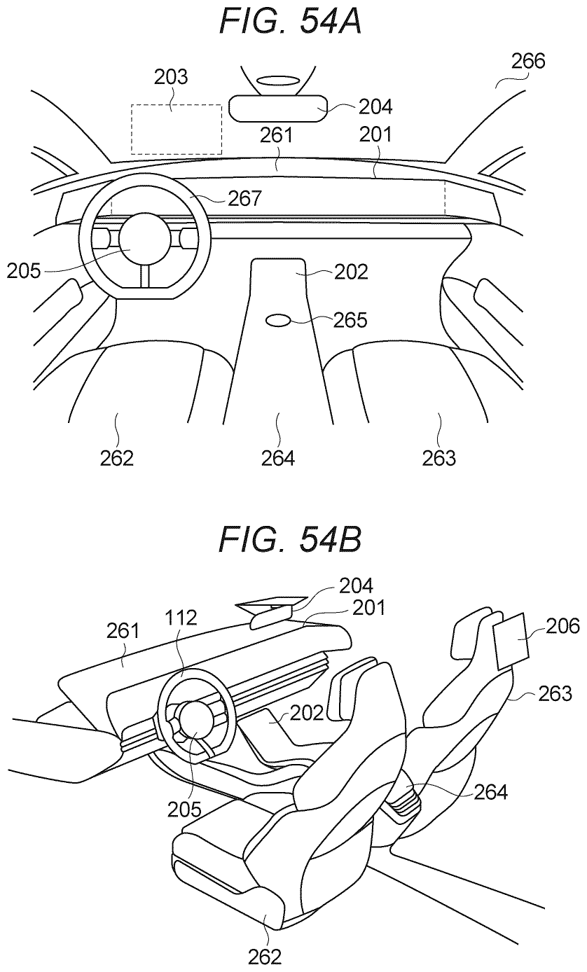

FIGS. 54A and 54B are diagrams illustrating a configuration example of a vehicle for which the liquid crystal display device in the present disclosure is employed. FIG. 54A illustrates an example of an inside of a vehicle 200 as viewed from a rear portion of the vehicle, and FIG. 54B illustrates an example of the inside of the vehicle 200 as viewed from the left rear of the vehicle.

The vehicle in FIGS. 54A and 54B includes a center display 201, a console display 202, a head-up display 203, a digital rear mirror 204, a steering wheel display 205, and a rear entertainment display 206.

The center display 201 is arranged on a dashboard 261 at a position facing a driver's seat 262 and a passenger seat 263. FIG. 54A illustrates an example of the center display 201 having a horizontally long shape extending from a driver's seat 262 side to a passenger seat 263 side, but screen size and an arrangement location of the center display 201 are not limited thereto. The center display 201 can display information detected by various sensors. As a specific example, the center display 201 can display a captured image captured by the image sensor, a distance image to an obstacle in front of or on a side of the vehicle measured by the TOF sensor, a body temperature of the occupant detected by the infrared sensor, and the like. The center display 201 can be used to display at least one piece of safety-related information, operation-related information, life logs, health-related information, authentication/identification-related information, or entertainment-related information, for example.

The safety-related information is information such as doze detection, looking-away detection, mischief detection of a child riding together, presence or absence of wearing a seat belt, and detection of leaving of an occupant based on a detection result of the sensor. The operation-related information is gesture information regarding the operation of the occupant detected using the sensor. The gesture may include operations of various facilities in the vehicle, for example, operations of an air conditioning equipment, a navigation device, an audio visual (AV) device, a lighting device, and the like. The life logs include life logs of all the occupants. For example, the life log includes an action record of each occupant. By acquiring and storing the life log, it is possible to confirm the state of the occupant when the accident occurs. The health-related information includes the body temperature of the occupant detected using the temperature sensor and information on the health condition of the occupant estimated on the basis of the detected body temperature. Alternatively, the information on the health condition of the occupant may be estimated on the basis of the face of the occupant captured by the image sensor. Furthermore, the information on the health condition of the occupant may be estimated on the basis of an answer content of the occupant obtained by talking with the occupant using the automatic voice. The authentication/identification-related information includes information such as a keyless entry function for performing face authentication using a sensor and an automatic adjustment function of a seat height and a position in face identification. The entertainment-related information includes operation information of the AV device by the occupant detected by the sensor, information of content suitable for the occupant detected and recognized by the sensor, and the like.

The console display 202 can be used to display the life log information, for example. The console display 202 is disposed near the shift lever 265 in the center console 264 between the driver's seat 262 and the passenger seat 263. The console display 202 can also display information detected by various sensors. Furthermore, the console display 202 may display an image of the periphery of the vehicle captured by the image sensor, or may display a distance image to an obstacle in the periphery of the vehicle.

The head-up display 203 is virtually displayed behind a windshield 266 in front of the driver's seat 262. The head-up display 203 can be used to display at least one piece of information including the safety-related information, the operation-related information, the life logs, the health-related information, the authentication/identification-related information, and the entertainment-related information, for example. Since the head-up display 203 is often virtually arranged in front of the driver's seat 262, it is suitable for displaying information directly related to the operation of the vehicle, such as the speed of the vehicle, the remaining amount of fuel, and the remaining amount of the battery.

The digital rear mirror 204 can display not only the rear of the vehicle but also the state of the occupant in the rear seat, and thus can be used to display the life log information of the occupant in the rear seat, for example.

The steering wheel display 205 is disposed near the center of a steering wheel 267 of the vehicle. The steering wheel display 205 can be used to display at least one piece of information including the safety-related information, the operation-related information, the life logs, the health-related information, the authentication/identification-related information, and the entertainment-related information, for example. In particular, since the steering wheel display 205 is close to the driver's hand, it is suitable for displaying life log information such as the body temperature of the driver, or for displaying information regarding the operation of an AV device, air conditioning equipment, or the like.

The rear entertainment display 206 is attached to the back side of the driver's seat 262 and the passenger seat 263, and is for viewing by an occupant in the rear seat. The rear entertainment display 206 can be used to display at least one piece of information including the safety-related information, the operation-related information, the life logs, the health-related information, the authentication/identification-related information, and the entertainment-related information, for example. In particular, because the rear entertainment display 206 is in front of the occupant in the rear seat, information related to the occupant in the rear seat is displayed. The rear entertainment display 206 may display, for example, information regarding the operation of an AV device or air conditioning equipment, or may display a result of measuring a body temperature or the like of the occupant in the rear seat by a temperature sensor 5.

The liquid crystal display devices according to the above embodiments and the like can be employed for the center display 201, the console display 202, the head-up display 203, the digital rear mirror 204, the steering wheel display 205, and the rear entertainment display 206.

### Seventh Application Example

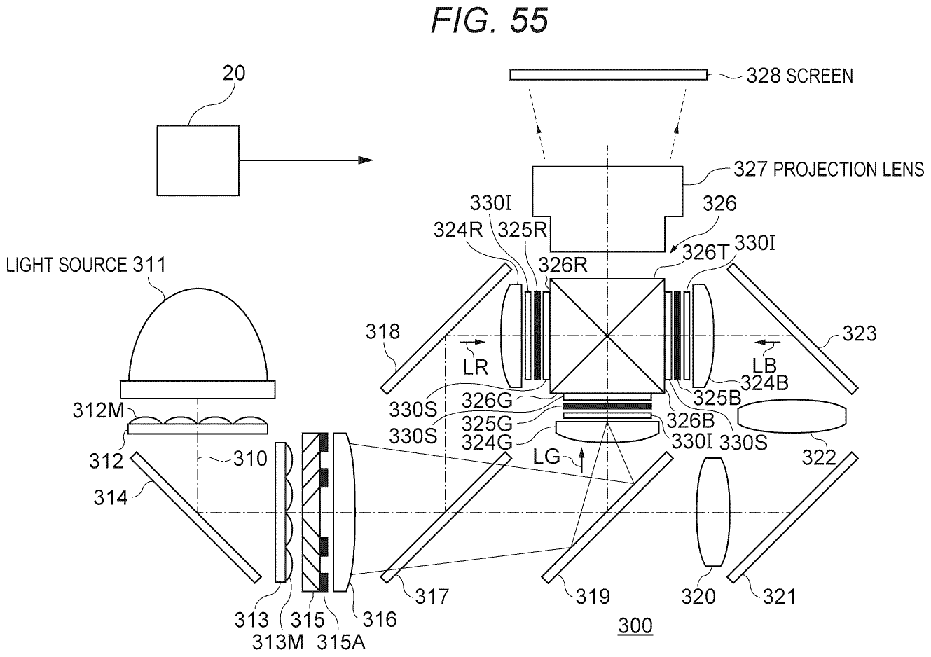

FIG. 55 is a diagram illustrating an optical configuration example of a liquid crystal projector. A liquid crystal projector 300 illustrated in FIG. 55 includes a light source 311 that emits light, a first lens array 312 arranged on an emission side of the light from the light source 311, a mirror 314 that reflects the light emitted from the first lens array 312 and that changes an optical path (optical axis 310) of the emitted light by 90°, and a second lens array 313 on which the light reflected from the mirror 314 is incident. The mirror 314 is preferably a total reflection mirror.

A plurality of microlenses 312M and 313M is two-dimensionally arranged in the first lens array 312 and the second lens array 313, respectively. The first lens array 312 and the second lens array 313 are used to make illuminance distribution of light uniform, and have a function of dividing incident light into a plurality of small light fluxes.

Note that a UV (Ultra Violet)/IR (Infrared) cut filter (not illustrated) may be installed between the light source 311 and the first lens array 312.

The light source 311 emits white light including red light, blue light, and green light required for color image display. The light source 311 includes a light emitter (not illustrated) that emits white light, and a reflector that reflects and collects light emitted from the light emitter.

As the light emitter, for example, a lamp such as an ultra-high pressure mercury lamp, a halogen lamp, a metal halide lamp, or a xenon lamp is used. The reflector desirably has a shape with good light collection efficiency, and has a rotationally symmetric concave surface shape such as a rotational ellipsoidal mirror or a rotational parabolic mirror. In addition, a light emission point of the light emitter is disposed at a focal position of the concave reflector.

The white light emitted from the light emitter of the light source 311 becomes substantially parallel light by the reflector, passes through the first lens array 312, and enters the mirror 314. The white light whose optical axis 310 is bent by 90° by the mirror 314 is incident on the second lens array 313.

The liquid crystal projector 300 illustrated in FIG. 55 includes a PS synthesis element 315, a condenser lens 316, and a dichroic mirror 317 on an emission side of light from the second lens array 313.

The PS synthesis element 315 is provided with a plurality of retardation plates 315A at positions corresponding to between adjacent microlenses in the second lens array 313. ½ wave plates are an example of the retardation plates 315A.

The PS synthesis element 315 separates the incident light into polarized light of a P-polarized component and an S-polarized component. Furthermore, the PS synthesis element 315 emits one of the two components of the separated polarized light from a polarization conversion element while maintaining a polarization direction (for example, the P-polarized light), and converts the other component of the polarized light (for example, the S-polarized component) into another polarized component (for example, the P-polarized component) by the action of the ½ wave plates 315A and emits the other polarized component.

The light emitted from the PS synthesis element 315 is condensed by the condenser lens 316 and enters the dichroic mirror 317.

The dichroic mirror 317 reflects, for example, red light LR in the incident light and transmits light of other colors, thereby color-separating the incident light into the red light LR and the other colors.

Furthermore, the liquid crystal projector 300 includes a mirror 318, a field lens 324R, an incident side polarizing plate 330I, a liquid crystal panel 325R, and an emission side polarizing plate 330S along an optical path of the red light LR color-separated by the dichroic mirror 317.

As the mirror 318, a total reflection mirror is preferably used. The mirror 318 reflects the red light LR color-separated by the dichroic mirror 317 toward the incident side polarizing plate 330I and the liquid crystal panel 325R.

As described above, the incident side polarizing plate 330I allows light in a direction coinciding with a polarization axis 330a in the red light LR incident from the mirror 318 to pass therethrough.

The liquid crystal panel 325R spatially modulates the red light LR incident through the incident side polarizing plate 330I according to input image data. In the modulated red light LR from the liquid crystal panel 325R, the emission side polarizing plate 330S allows light in a direction coinciding with a polarization axis 330b to pass therethrough.

The liquid crystal projector 300 includes a dichroic mirror 319 along an optical path of the light of the other colors separated by the dichroic mirror 317. The dichroic mirror 319 reflects, for example, green light LG and transmits blue light LB in the incident light, thereby color-separating the incident light into the green light LG and the blue light LB.

A field lens 324G, an incident side polarizing plate 330I, a liquid crystal panel 325G, and an emission side polarizing plate 330S are provided along an optical path of the green light LG color-separated by the dichroic mirror 319.

The incident side polarizing plate 330I allows light in a direction coinciding with a polarization axis 330a in the green light LG incident from the dichroic mirror 319 to pass therethrough.

The liquid crystal panel 325G spatially modulates the green light LG incident through the incident side polarizing plate 330I according to input image data.

In the modulated green light LG from the liquid crystal panel 325G, the emission side polarizing plate 330S allows light in a direction coinciding with the polarization axis 330b to pass therethrough.

Furthermore, a relay lens 320, a mirror 321, a relay lens 322, a mirror 323, a field lens 324B, an incident side polarizing plate 330I, a liquid crystal panel 325B, and an emission side polarizing plate 330S are provided along an optical path of the blue light LB color-separated by the dichroic mirror 319.

The mirrors 321 and 323 are preferably total reflection mirrors. The mirror 321 reflects the blue light LB incident through the relay lens 320 toward the mirror 323. The mirror 323 reflects the blue light LB reflected by the mirror 321 and incident through the relay lens 322 toward the incident side polarizing plate 330I and the liquid crystal panel 325B.

The incident side polarizing plate 330I allows light in a direction coinciding with a polarization axis 330a in the green light LG incident from the mirror 323 to pass therethrough.

The liquid crystal panel 325B spatially modulates the blue light LB reflected by the mirror 323 and incident through the field lens 324B and the incident side polarizing plate 330I according to input image data.

In the modulated blue light LB from the liquid crystal panel 325B, the emission side polarizing plate 330S allows light in a direction coinciding with the polarization axis 330b to pass therethrough. A cross prism 326 having a function of combining these three beams of color light is installed at a position where the optical paths of the red light LR, the green light LG, and the blue light LB intersect.

As an example, the cross prism 326 is formed by joining four right angle prisms having incident surfaces 326R, 326G, and 326B, respectively, on which the red light LR, the green light LG, and the blue light LB are incident, and an emission surface 326T from which light obtained by combining the red light LR, the green light LG, and the blue light LB is emitted.

In the liquid crystal projector 300, a dichroic film is coated on a joint surface of each right angle prism such that the green light LG incident on the cross prism 326 is transmitted toward an emission surface 326T side, and the red light LR and the blue light LB incident on the cross prism 326 are reflected toward the emission surface 326T side.

The cross prism 326 thus combines the three beams of color light incident on the incident surfaces 326R, 326G, and 326B and emits the combined light from the emission surface 326T.

In addition, the liquid crystal projector 300 also includes a projection lens 327 for projecting the combined light emitted from cross prism 326 toward a screen 328. The projection lens 327 preferably includes a plurality of lenses, and has a zoom function for adjusting a size of an image to be projected on the screen 328 and a focus function.

Note that the above-described effects can be obtained even when the present disclosure is applied to not only the projection type liquid crystal display element but also any type of device such as a reflection type liquid crystal display element or an LCOS.

In addition, the above-described effects can be expected even when the present disclosure is applied to any type of liquid crystal display element such as a liquid crystal display element with a built-in drive, a liquid crystal display element with a drive circuit externally attached thereto, a liquid crystal display element with various sizes of a diagonal of about 1 inch to 15 inches or more, a simple matrix type, a TFD active matrix type, a passive matrix drive type, a polarization-rotation mode, and a birefringence mode.

Note that the present technology may have the following configurations.

(1) A liquid crystal display device including:
a first electrode provided in an effective pixel region in which pixels are arranged in a two-dimensional array;
a second electrode opposed to the first electrode in a first direction;
a liquid crystal provided between the first electrode and the second electrode;
a first protective film and a second protective film opposed to each other in the first direction with the liquid crystal sandwiched between the first protective film and the second protective film in the effective pixel region;
a first alignment film covered with the first protective film in the effective pixel region;
a second alignment film covered with the second protective film in the effective pixel region; and
a third electrode opposed to the second electrode in the first direction in a non-effective region located outside the effective pixel region, in which at least one of the first alignment film and the second alignment film is exposed in the non-effective region and is in contact with the liquid crystal.

(2) The liquid crystal display device according to (1), in which the first alignment film and the second alignment film provided in the non-effective region are separated from the first alignment film and the second alignment film provided in the effective pixel region.

(3) The liquid crystal display device according to (2), in which the second electrode provided in the non-effective region is separated from the second electrode provided in the effective pixel region.

(4) The liquid crystal display device according to (2), further including a sealant in contact with the first alignment film and the second alignment film outside the effective pixel region, in which
the first alignment film and the second alignment film provided in the non-effective region are separated from the first alignment film and the second alignment film in contact with the sealant.

(5) The liquid crystal display device according to (4), further including a plug that closes an injection port of the liquid crystal, in which
the first alignment film and the second alignment film each have a protrusion protruding toward the plug at a portion facing the plug.

(6) The liquid crystal display device according to (4), in which the first alignment film and the second alignment film surround the effective pixel region with multiple layers.

(7) The liquid crystal display device according to (4), in which refresh driving of applying different voltages to a plurality of the first electrodes adjacent to each other is performed.

(8) The liquid crystal display device according to (7), in which at a time of the refresh driving, the second electrode and the third electrode disposed on a sealant side in the non-effective region have a same potential.

(9) The liquid crystal display device according to (7) or (8), in which at a time of the refresh driving, a moving image pattern in which gradation of voltages applied to the plurality of first electrodes is scrolled is displayed in the effective pixel region.

(10) The liquid crystal display device according to (7) or (8), in which the refresh driving is performed alternately with normal display based on a video signal.

(11) The liquid crystal display device according to (7) or (8), in which the refresh driving is performed every other image display unit.

(12) The liquid crystal display device according to (7) or (8), in which the refresh driving is performed in two image display units.

(13) The liquid crystal display device according to (9), in which the gradation of the voltages is set within a range of 2 V to 3 V.

(14) The liquid crystal display device according to (9), in which a first moving image pattern and a second moving image pattern are alternately displayed at the time of the refresh driving, and
a range of the gradation of the voltages in the second moving image pattern is narrower than a range of the gradation of the voltages in the first moving image pattern.

(15) The liquid crystal display device according to (7) or (8), further including a signal processing circuit that extracts, at a time of the refresh driving, an adjacent pixel region in which pixels having a same grayscale value and adjacent to each other are arranged in the effective pixel region and that sets a voltage difference between the first electrode and the second electrode to be different between the adjacent pixels in the adjacent pixel region.

(16) The liquid crystal display device according to (1), in which the pixels each include a first pixel portion arranged in a light transmission region in the effective pixel region and a second pixel portion arranged in a non-light transmission region in the effective pixel region,
the first pixel portion includes a first pixel transistor, and the second pixel portion includes a second pixel transistor, and
the second pixel transistor is connected to a gate line and a signal line different from a gate line and a signal line of the first pixel transistor.

(17) The liquid crystal display device according to (1), in which the pixels each include a first pixel portion arranged in a light transmission region in the effective pixel region and a second pixel portion arranged in a non-light transmission region in the effective pixel region,
the first pixel portion includes a first pixel transistor, and the second pixel portion includes a second pixel transistor, and
the second pixel transistor is connected to a gate line different from a gate line of the first pixel transistor and a same signal line as a signal line of the first pixel transistor.

(18) The liquid crystal display device according to (1), in which the pixels each include a first pixel portion arranged in a light transmission region in the effective pixel region and a second pixel portion arranged in a non-light transmission region in the effective pixel region,
the first pixel portion includes a pixel transistor, and the second pixel portion includes a resistance element, and
the resistance element is connected to two voltage pass lines having different potentials.

(19) The liquid crystal display device according to (18), in which a series connection of a plurality of the resistance elements is divided by the voltage pass lines in such a way as to generate a lateral electric field having two types of voltage changes in the effective pixel region.

(20) An electronic apparatus including a liquid crystal display device, in which
the liquid crystal display device includes:
a first electrode provided in an effective pixel region in which pixels are arranged in a two-dimensional array;
a second electrode opposed to the first electrode in a first direction;
a liquid crystal provided between the first electrode and the second electrode;
a first protective film and a second protective film opposed to each other in the first direction with the liquid crystal sandwiched between the first protective film and the second protective film in the effective pixel region;
a first alignment film covered with the first protective film in the effective pixel region;
a second alignment film covered with the second protective film in the effective pixel region; and
a third electrode opposed to the second electrode in the first direction in a non-effective region located outside the effective pixel region, and
at least one of the first alignment film and the second alignment film is exposed in the non-effective region and is in contact with the liquid crystal.

Aspects of the present disclosure are not limited to the above-described individual embodiments, but include various modifications that can be conceived by those skilled in the art, and the effects of the present disclosure are not limited to the above-described contents. In other words, various additions, modifications, and partial deletions may be made without departing from the conceptual idea and spirit of the present disclosure derived from the matters defined in the claims and equivalents thereof.

### REFERENCE SIGNS LIST

1 Liquid crystal display device
11 Voltage pass line
12 Voltage pass line
20 Signal processing circuit
41 Voltage pass line
42 Voltage pass line
50 Pixel
50a First pixel portion
50b Second pixel portion
51 Effective pixel region
52 Non-effective region
430 Counter substrate
430a Counter substrate
431 Counter electrode
431a Counter electrode
431b Counter electrode
432 Second alignment film
432a Second alignment film
432b Second alignment film
432b1 Protrusion
432c Second alignment film
432d Second alignment film
433 Second protective film
440 Liquid crystal
440a Liquid crystal
450 TFT substrate
451 Gate line
452 Signal line
453 Pixel transistor
454 Pixel electrode
457 First alignment film
457a First alignment film
457b First alignment film
457b1 Protrusion
457c First alignment film
457d First alignment film
457e First alignment film
458 First protective film
459 Electrode
459a Electrode
459b Electrode
459c Electrode
490 Sealant
491 Injection port
492 Plug
501 Pass gate line
502 Pass signal line
503 Pixel transistor
505 Resistance element
511 Adjacent pixel region
540 Vertical drive circuit

1. A liquid crystal display device comprising:
a first electrode provided in an effective pixel region in which pixels are arranged in a two-dimensional array;
a second electrode opposed to the first electrode in a first direction;
a liquid crystal provided between the first electrode and the second electrode;
a first protective film and a second protective film opposed to each other in the first direction with the liquid crystal sandwiched between the first protective film and the second protective film in the effective pixel region;
a first alignment film covered with the first protective film in the effective pixel region;
a second alignment film covered with the second protective film in the effective pixel region; and
a third electrode opposed to the second electrode in the first direction in a non-effective region located outside the effective pixel region, wherein
at least one of the first alignment film and the second alignment film is exposed in the non-effective region and is in contact with the liquid crystal.

2. The liquid crystal display device according to claim 1, wherein the first alignment film and the second alignment film provided in the non-effective region are separated from the first alignment film and the second alignment film provided in the effective pixel region.

3. The liquid crystal display device according to claim 2, wherein the second electrode provided in the non-effective region is separated from the second electrode provided in the effective pixel region.

4. The liquid crystal display device according to claim 2, further comprising a sealant in contact with the first alignment film and the second alignment film outside the effective pixel region, wherein
the first alignment film and the second alignment film provided in the non-effective region are separated from the first alignment film and the second alignment film in contact with the sealant.

5. The liquid crystal display device according to claim 4, further comprising a plug that closes an injection port of the liquid crystal, wherein
the first alignment film and the second alignment film each have a protrusion protruding toward the plug at a portion facing the plug.

6. The liquid crystal display device according to claim 4, wherein the first alignment film and the second alignment film surround the effective pixel region with multiple layers.

7. The liquid crystal display device according to claim 4, wherein refresh driving of applying different voltages to a plurality of the first electrodes adjacent to each other is performed.

8. The liquid crystal display device according to claim 7, wherein at a time of the refresh driving, the second electrode and the third electrode disposed on a sealant side in the non-effective region have a same potential.

9. The liquid crystal display device according to claim 7, wherein at a time of the refresh driving, a moving image pattern in which gradation of voltages applied to the plurality of first electrodes is scrolled is displayed in the effective pixel region.

10. The liquid crystal display device according to claim 7, wherein the refresh driving is performed alternately with normal display based on a video signal.

11. The liquid crystal display device according to claim 7, wherein the refresh driving is performed every other image display unit.

12. The liquid crystal display device according to claim 7, wherein the refresh driving is performed in two image display units.

13. The liquid crystal display device according to claim 9, wherein the gradation of the voltages is set within a range of 2 V to 3 V.

14. The liquid crystal display device according to claim 9, wherein a first moving image pattern and a second moving image pattern are alternately displayed at the time of the refresh driving, and
a range of the gradation of the voltages in the second moving image pattern is narrower than a range of the gradation of the voltages in the first moving image pattern.

15. The liquid crystal display device according to claim 7, further comprising a signal processing circuit that extracts, at a time of the refresh driving, an adjacent pixel region in which pixels having a same grayscale value and adjacent to each other are arranged in the effective pixel region and that sets a voltage difference between the first electrode and the second electrode to be different between the adjacent pixels in the adjacent pixel region.

16. The liquid crystal display device according to claim 1, wherein the pixels each include a first pixel portion arranged in a light transmission region in the effective pixel region and a second pixel portion arranged in a non-light transmission region in the effective pixel region,
the first pixel portion includes a first pixel transistor, and the second pixel portion includes a second pixel transistor, and
the second pixel transistor is connected to a gate line and a signal line different from a gate line and a signal line of the first pixel transistor.

17. The liquid crystal display device according to claim 1, wherein the pixels each include a first pixel portion arranged in a light transmission region in the effective pixel region and a second pixel portion arranged in a non-light transmission region in the effective pixel region,
the first pixel portion includes a first pixel transistor, and the second pixel portion includes a second pixel transistor, and
the second pixel transistor is connected to a gate line different from a gate line of the first pixel transistor and a same signal line as a signal line of the first pixel transistor.

18. The liquid crystal display device according to claim 1, wherein the pixels each include a first pixel portion arranged in a light transmission region in the effective pixel region and a second pixel portion arranged in a non-light transmission region in the effective pixel region,
the first pixel portion includes a pixel transistor, and the second pixel portion includes a resistance element, and
the resistance element is connected to two voltage pass lines having different potentials.

19. The liquid crystal display device according to claim 18, wherein a series connection of a plurality of the resistance elements is divided by the voltage pass lines in such a way as to generate a lateral electric field having two types of voltage changes in the effective pixel region.

20. An electronic apparatus comprising a liquid crystal display device, wherein
the liquid crystal display device includes:
a first electrode provided in an effective pixel region in which pixels are arranged in a two-dimensional array;
a second electrode opposed to the first electrode in a first direction;
a liquid crystal provided between the first electrode and the second electrode;
a first protective film and a second protective film opposed to each other in the first direction with the liquid crystal sandwiched between the first protective film and the second protective film in the effective pixel region;
a first alignment film covered with the first protective film in the effective pixel region;
a second alignment film covered with the second protective film in the effective pixel region; and
a third electrode opposed to the second electrode in the first direction in a non-effective region located outside the effective pixel region, and
at least one of the first alignment film and the second alignment film is exposed in the non-effective region and is in contact with the liquid crystal.
